(19) United States
(12) Patent Application Publication
(10) Pub. No.: US 2007/0274672 A1
(43) Pub. Date: Nov. 29, 2007

(54) Broadcast Video/Audio Data Recording Method And Apparatus And Recording Medium

(75) Inventor: Satoshi Itoi, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: NEC CORPORATION, TOKYO (JP)

(21) Appl. No.: 10/594,143

(22) PCT Filed: Mar. 28, 2005
(86) PCT No.: PCT/JP05/06531

§ 371 Date: Sep. 26, 2006

(30) Foreign Application Priority Data
Mar. 26, 2004 (JP) 2004-092420
Aug. 13, 2004 (JP) 2004-235755

(51) Int. Cl. H04N 5/92

(52) U.S. Cl. 386/46

(57) ABSTRACT

Along with a first file (501) for recording management data (506), a second file (503) for recording ordinary digital broadcast (508), ordinary broadcast with program-link-type data broadcast (509), independent-type data broadcast (510), audio broadcast (511) and so on, there are provided a third file (504) for recording analog broadcast video/audio data, and a subsidiary file for recording various data. The subsidiary file is able to record data for various usages, including MPEG video data (513), MPEG audio data (514), JPEG data (515), PNG data (516), MNG data (517), BML data (518), game data (519), electronic program guide data (520), and so on. According to this configuration, various information such as digital broadcast without data broadcast, ordinary broadcast with program-link-type data broadcast, independent-type data broadcast, audio broadcast, text broadcast, analog broadcast, and broadcast-related Internet information can be easily recorded on a video recorder such as DVD. Further, the recorded data can be copied or moved after converting the format to enable the recorded data to be DVD reproduced with other equipment, rapidly transmitted, deleted, or edited. The recorded data can also be partially retrieved for reuse.

### TECHNICAL FIELD

This invention relates to a method and apparatus for reproducing record of digital broadcast data, analog broadcast video/audio data, related information other than broadcast, such as Internet data, and a recording medium for recording such information, for use in a recording apparatus such as a hard-disk/DVD combo video recorder, a DVD video recorder, a DVD stream recorder, and a hard-disk video recorder.

### BACKGROUND ART

Conventionally, video and stream-related application formats used in DVD (Digital Versatile Disc) have been standardized by DVD Forum, as read-only DVD-Video format, DVD-VR (Video Recording) format easy to record, reproduce and edit, and DVD-SR (Stream Recording) format easy to directly record and reproduce a broadcast or transmission stream.

The DVD-Video is a read-only format for disks on which contents such as movies are preliminarily recorded, and a main target thereof is a home theater system. The DVD-VR is a format whose main object is to digitize analog video and record the video after MPEG-2 encoding, and a main target thereof is analog broadcast recording and video cameras. DVD-SR is a format for recording data received as an MPEG stream basically as it is, and a main target thereof is direct recording of digital broadcast. Currently, the DVD-Video systems are widely marketed worldwide, and the DVD-VR systems are also becoming widely used. The DVD-SR systems, however, have not been marketed yet.

Conventionally, when recording broadcast video/audio data by means of a DVD or the like, the format has been decided in consideration only given to whether digital broadcast is directly recorded or analog broadcast is recorded after digitizing the same. No consideration has been given to data broadcast recording.

This means that consideration has been made only about making the analog broadcast and the digital broadcast coexist in the same medium in DVD-VR or DVD-SR format. As for the digital broadcast, consideration has only been given to directly recording on a medium without processing the same. When data broadcast is to be recorded by itself, it has for example been considered that the data in the data broadcast is recorded by arranging the same in PES_private_data defined by MPEG-2 format.

Japanese Laid-Open Patent Publication No. 2003-288767 (Patent Publication 1) proposes a video/audio stream recording method which realizes multifunctional recording white maintaining compatibility, and enables optimal data exchange with video recording equipment such as a video recorder and optimal data recording.

Additionally, the present inventors have proposed, in Japanese Patent Application No. 2004-12264 (Patent Publication 2) and so on, a recording and reproducing method for recording and reproducing data broadcast as well as ordinary broadcast.

### DISCLOSURE OF THE INVENTION

Problems To Be Solved by the Invention:

However, when broadcast video/audio data is recorded by using the recording methods as described, the following problems may arise.

When digital broadcast is recorded on a medium in DVD-SR format, the data on the medium cannot be read by a DVD player or a DVD recorder supporting ordinary DVD-Video or DVD-VR format.

Further, the data recorded in the DVD-Video or DVD-VR format after MPEG encoding analog broadcast cannot be transmitted to other devices for the purpose of data communication.

Further, variable-speed reproduction, time search, title search or chapter search cannot be performed for data files in which digital broadcast is recorded by multi-channel recording or the Like without building a time map.

On the other hand, although data broadcast can be recorded in PES_private_data, it is not defined by the format because of being recorded as private data. Therefore, compatibility cannot be provided among different apparatuses. Even if compatibility is provided, when actual broadcast and data broadcast are multiplexed into one stream, it will be very difficult to store, edit, delete, process, or specially reproduce the data of the data broadcast separately from the actual broadcast.

When digital broadcast is directly recorded in DVD-SR as well, detail cannot be known about separation between actual broadcast and data broadcast, contents of data broadcast, or data broadcast channels, unless the recorded stream is searched. Even if the details are known, when actual broadcast and data broadcast are multiplexed into one stream, it will be very difficult to store, edit, delete, process, or specially reproduce the data of the data broadcast separately from the actual broadcast.

Patent Publication 1 does not mention at all about recording data broadcast or about problems that possibly arise in the recording thereof.

Patent Publication 2 does not mention about a method of recording or reproducing broadcast data represented in transport stream (TS) and video/audio data (non-broadcast data) represented in program stream (PS). In other words, Patent Publication 2 does not consider about recording broadcast other than data broadcast or non-broadcast related data.

It is therefore an object of the present invention to provide a broadcast video/audio data recording method capable of processing broadcast video/audio data easily and as desired.

It is another object of the present invention is to provide an apparatus for recording and/or reproducing data according to the recording method described above.

It is still another object of the present invention is to provide a recording medium on which data is recorded according to the recording method described above and a recording medium capable of recording data streams having different formats.

It is still another object of the present invention is to provide a method and apparatus for recording/reproducing data broadcast, broadcast other than data broadcast, and related data other than broadcast, namely data streams having different formats.

Means for Solving the Problems:

The present invention solves the problems described above, and is characterized by the followings.

A first aspect of the present invention provides a broadcast video/audio data recording method characterized in that management data is recorded in a first file, a stream representing broadcast in a TS (Transport Stream) is recorded in a second file, a stream representing video and audio in a PS (Program Stream) is recorded in a third file, a subsidiary file is provided separately from the first to third files, and the contents of the data in the files are indicated by the management data in the first file.

A second aspect of the present invention provides a broadcast video/audio data recording method, characterized in that the subsidiary file records all or part of the input broadcast, video and audio, or the broadcast, video and audio copied or moved from all or part of the broadcast, video and audio recorded in the second or third file.

A third aspect of the present invention provides a broadcast video/audio data recording method characterized in that the subsidiary file is composed of a plurality of files, and all or part of the input broadcast video and audio or the broadcast, video and audio copied or moved from all or part of the broadcast, video and audio recorded in the second or third file recorded in the plurality of files in the subsidiary file such that the respective combinations of animated pictures having a same encoding format, audios having a same encoding format, still-pictures having a same encoding format, animations having a same encoding format, text data having a same encoding format, game data having a same encoding format, electronic program guide data having a same encoding format, graphic having a same encoding format, and three-dimensional video data having a same encoding format are recorded in the same files in the subsidiary file.

A fourth aspect of the present invention provides a broadcast video/audio data recording method characterized in that data broadcast is recorded in any of the second, third, and subsidiary files, all or part of the input broadcast, video and audio, or the broadcast, video and audio copied or moved from all or part of the broadcast, video and audio recorded in the second, third, or subsidiary file is recorded in the fourth or the fifth file in the subsidiary file.

A fifth aspect of the present invention provides a broadcast video/audio data recording method characterized in that all or part of the input broadcast video/audio data or all or part of the data in the files is directly recorded in or copied or moved to a destination file if the format thereof corresponds to that of the destination file, whereas if the format thereof does not correspond to that of the destination file, it is recorded in or copied or moved to the destination file after being converted to the corresponding format.

A sixth aspect of the present invention provides a broadcast video/audio data recording method characterized in that the PS stream in the third file is a stream obtained by PS encoding analog broadcast.

A seventh aspect of the present invention provides a broadcast video/audio data recording method characterized in that the PS stream in the third file is a stream obtained by transcoding digital broadcast from TS to PS.

An eighth aspect of the present invention provides a broadcast video/audio data recording method characterized in that the broadcast stream represented in TS and recorded in the second file is converted into a video/audio stream represented in PS, which is then recorded in the third file by copying or moving the same, and the recorded information is indicated by the management data.

A ninth aspect of the present invention provides a characterized in that the video/audio stream represented in TS and recorded in the third file is converted into a broadcast stream represented in PS, which is then recorded in the second file by copying or moving the same, and the recorded information is indicated by the management data.

A tenth aspect of the present invention provides a broadcast video/audio data recording method characterized in that related information other than broadcast is recorded in the subsidiary file, and the contents of the related information other than broadcast are indicated by the management data.

An eleventh aspect of the present invention provides a broadcast video/audio data recording method characterized in that related information other than broadcast is recorded in a new file separate from the first to third files and the subsidiary file, and the contents of the related information other than broadcast are indicated by the management data.

A twelfth aspect of the present invention provides a characterized in that the data broadcast includes program-link-type data broadcast, independent-type data broadcast, audio or radio broadcast, and text broadcast.

A 13th aspect of the present invention provides a broadcast video/audio data recording method characterized in that the program-link-type data broadcast is recorded in the second file, the independent-type data broadcast, the audio or radio broadcast, or the text broadcast is recorded in the subsidiary file.

A 14th aspect of the present invention provides a broadcast video/audio data recording method characterized in that the data to be copied or moved is all or part of animated picture data, audio data, still-picture data, animation, text data, game data, electronic program guide data, graphic, and three-dimensional video data.

A 15th aspect of the present invention provides a broadcast video/audio data recording method characterized in that the related information other than broadcast is all or part of broadcast-related Internet information, Internet additional information such as program additional information, director's cut information, director's comment information, E-commerce information, chat information, and prior notice information, and Internet broadcast information.

A 16th aspect of the present invention provides a broadcast video/audio data recording method characterized in that there are provided a first file for recording management data and a data file for recording as stored data at least either input broadcast video/audio data or recorded broadcast video/audio data obtained as a result of copying or moving, and the stored data is recorded in the data file in a format indicating the management data.

A 17th aspect of the present invention provides a broadcast video/audio data recording method characterized in that the broadcast video/audio data represented in TS is recorded in a second file, while broadcast video/audio data represented in PS is recorded in a third file, and the recorded data in the second and/or third file(s) is selectively copied or moved to the data file.

An 18th aspect of the present invention provides a broadcast video/audio data recording method characterized in that there is provided a fourth file for storing data obtained by copying or moving at least part of the input broadcast video/audio data or the recorded data in the second or third file, as the data file.

A 19th aspect of the present invention provides a broadcast video/audio data recording method, characterized in that the management data is provided, including all or part of a broadcast recording file identification flag, a related information recording file identification flag other than broadcast, a broadcast identification flag, and a related information identification flag other than broadcast, and these flags indicate all or part of the file in which the broadcast video/audio data is recorded, the file in which the related information other than broadcast is recorded, the contents of the recorded broadcast video/audio data, and the contents of the recorded related information other than broadcast.

A 20th aspect of the present invention provides a broadcast video/audio data recording method, characterized in that; the broadcast recording file identification flag and the related information recording file identification flag other than broadcast indicate whether or not ordinary digital broadcast without data broadcast, ordinary digital broadcast with program-link-type data broadcast, independent-type data broadcast, audio or radio broadcast, text broadcast, and analog broadcast are recorded in their corresponding files, or the files in which the respective broadcasts are recorded, or indicate whether or not related information other than broadcast is recorded in its corresponding file, or the file in which the related information other than broadcast is recorded; the broadcast identification flag and the related information identification flag other than broadcast indicate all or part of: whether or not ordinary digital broadcast without data broadcast, ordinary digital broadcast with program-link-type data broadcast, independent-type data broadcast, audio or radio broadcast, text broadcast, analog broadcast, and related information other than broadcast are recorded in their corresponding streams, whether the relevant data in the recorded broadcast data or the recorded related information other than broadcast has been directly recorded or has been copied or moved from other files; whether there is a source or not when the data has been copied or moved, and, when there is a source, a file name, a source stream name, and source stream number; which type of data the source data and the recorded data are when the data has been copied or moved and its source is known, while otherwise the recorded data is, among animated pictures, audio, still pictures, animation, text data, game data, electronic program guide data, graphic data, and three-dimensional video data; an animated picture data compression method when the data is animated picture data, an audio data compression method when the data is audio, a still-picture data compression method when the data is still-picture data, an animation data compression method when the data is animation data, a text data compression display method when the data is text data, a game data method when the data is game data, an electronic program guide method when the data is electronic program guide data, a graphic method when the data is graphic, a three-dimensional video data method when the data is three-dimensional video data, and a stream mode, and a flag indicating whether the related information other than broadcast is ordinary Internet data or streaming data or other data.

A 21st aspect of the present invention provides a broadcast video/audio data recording method, characterized in that the first file records as the management data all or part of: a broadcast recording file identification flag, a related information recording file identification flag other than broadcast, a broadcast identification flag, and a related information identification flag other then broadcast; a flag which indicates whether the data broadcast transmission method is the data carousel mode, or the event message transmission mode, or the mode including both, a flag which indicates, in case of data carousel broadcast, whether the mode is for recording all the data or for recording only updated data, a flag which indicates, in broadcast of updatable data such as news, weather forecast, and stock information, whether the automatic update of old data with new data is set ON or OFF, a flag which indicates whether or not the latest data update start time and end time and a time map exist, and a flag which indicates whether the stream is an ordinary broadcast stream or a server-type broadcast stream.

A 22nd aspect of the present invention provides a broadcast video/audio data recording method characterized in that it is indicated which the animated picture data compression method is, MPEG video, or H.264 video, or Windows (registered trademark) Media video, which the audio data compression method is, MPEG audio, or Dolby audio, or DTS audio, and which the stilt-picture data compression method is, JPEG or PNG.

A 23rd aspect of the present invention provides a broadcast video/audio data reproducing apparatus for recording data by the recording method according to the first aspect, and/or a broadcast video/audio data reproducing apparatus for reproducing the data by the recording method according to the first aspect.

A 24th aspect of the present invention provides a broadcast video/audio data recording apparatus for recording data by the recording method according to the 16th aspect, and/or broadcast video/audio data reproducing apparatus for reproducing the data by the recording method according to the 16th aspect.

A 25th aspect of the present invention provides a broadcast video/audio data recording medium recorded by the recording method according to the first aspect.

A 26th aspect of the present invention provides a broadcast video/audio data recording medium recorded by the recording method according to the 16th aspect.

A 27th aspect of the present invention provides a data stream recording method for recording a data stream by storing data streams having mutually different formats in separate files, respectively, converting the formats between the stored data streams, and adding data corresponding to the converted format.

A 28th aspect of the present invention provides the data stream recording method according to the 27th aspect characterized in that the data streams include a transport stream (TS) and a program stream (PS).

A 29th aspect of the present invention provides the data stream recording method according to the 27th aspect, characterized in that the transport stream (TS) is a broadcast data stream, while the program stream (PS) is a non-broadcast data stream or a stream generated from broadcast, and management data for distinguishing the TS from the PS is stored in a separate file.

A 30th aspect of the present invention provides a data stream record reproduction apparatus characterized by comprising: two files for storing data streams having mutually different formats, respectively; means for converting the mutually different formats between the data streams; and another file for storing the converted data streams according to the converted format thereof, and the data streams is reproduced from the other file.

A 31st aspect of the present invention provides the data stream record reproduction apparatus according to the 30th aspect, characterized by further comprising data storing means for distinguishing the mutually different data streams.

A 32nd aspect of the present invention provides a recording medium characterized by having formats capable of supporting data streams having mutually different formats.

A 33rd aspect of the present invention provides a broadcast video/audio data recording apparatus characterized by comprising: a first file for recording management data; a second file for recording a stream in which broadcast is represented in TS (Transport Stream); a third file for recording a stream in which video and audio is represented in PS (Program Stream); and a subsidiary file provided separately from the first to third files, the contents of the broadcast video/audio data recorded in the files being indicated by the management data.

A 34th aspect of the present invention provides the broadcast video/audio data recording apparatus according to the 33rd aspect, characterized in that the subsidiary file includes a fourth file for recording data copied or moved from all or part of the input broadcast, video and audio, or all or part of the broadcast, video and audio recorded in the second or third file.

A 35th aspect of the present invention provides the broadcast video/audio data recording apparatus according to the 33rd aspect, characterized in that the subsidiary file includes files for recording data which are copied or moved from all or part of the input broadcast, video and audio, or all or part of the broadcast, video and audio recorded in the second or third file, by combining animated pictures having a same encoding format, audios having a same encoding format, still pictures having a same encoding format, animations having a same encoding format, text data having a same encoding format, game data having a same encoding format, and electronic program guide data having a same encoding format, graphic having a encoding format, and three-dimensional video data having a same encoding format, and recording them in the separate files, respectively, the contents of the broadcast video/audio data recorded in the files being indicated by the management data.

A 36th aspect of the present invention provides the broadcast video/audio data recording apparatus according to the 33rd aspect, characterized in that the second or third file records data broadcast, and the subsidiary file includes a fourth or fifth file for recording data which are copied or moved from all or part of the input broadcast, video and audio, or all or part of the broadcast, video and audio recorded in the second or third file, the contents of the broadcast video/audio data recorded in the files being indicated by the management data.

A 37th aspect of the present invention provides the broadcast video/audio data recording apparatus according to 36th aspect, characterized by comprising files for recording data which are copied or moved from all or part of the input broadcast, video and audio, or all or part of the broadcast, video and audio recorded in the second or third file, by combining animated pictures having a same encoding format, audios having a same encoding format, still pictures having a same encoding format, animations having a same encoding format, text data having a same encoding format, game data having a same encoding format, and electronic program guide data having a same encoding format, graphic having a encoding format, and three-dimensional video data having a same encoding format, and recording them in the separate files, respectively, the contents of the broadcast video/audio data recorded in the files being indicated by the management data.

A 38th aspect of the present invention provides a broadcast video/audio data reproducing apparatus characterized by comprising means for reproducing the data recorded in the broadcast video/audio data recording apparatus according to the 33rd aspect with reference to the management data in the first file.

A 39th aspect of the present invention provides the broadcast video/audio data recording apparatus according to the 33rd aspect, characterized in that subsidiary file includes animated pictures, audio, still pictures, animation, text data, game data, electronic program guide data, graphic, and three-dimensional video data each of which is assigned with header information.

A 40th aspect of the present invention provides the broadcast video/audio data recording apparatus according to the 33rd aspect, characterized in that the data in the subsidiary file is recorded by combining animated pictures having a same encoding format, audios having a same encoding format, still pictures having a same encoding format, animations having a same encoding format, text data having a same encoding format, game data having a same encoding format, and electronic program guide data having a same encoding format, graphic having a encoding format, and three-dimensional video data having a same encoding format, and adding header information to each of the combinations of the data.

A 41st aspect of the present invention provides the broadcast video/audio data recording apparatus according to the 33rd aspect, characterized in that the header information includes at Least some of: a flag indicating whether ordinary digital broadcast without data broadcast, ordinary digital broadcast with program-link-type data broadcast, independent-type data broadcast, audio or radio broadcast, text broadcast, analog broadcast, or related information other than broadcast is recorded or not; a flag indicating whether the recorded broadcast data or related information other than broadcast has been directly recorded or copied or moved from another file; a flag which indicates whether there is a source when the data has been copied or moved,; a file name, a source stream name, and a source stream number when there is a source; a flag which indicates which the source data and the recorded data are, when the data has been copied or moved and the source is known, and otherwise indicates which the recorded data is, among animated pictures, audio, still pictures, animation, text data, game data, electronic program guide data, graphic, and three-dimensional video data; a flag which indicates an animated picture data compression method when the data is animated pictures, an audio data compression method when the data is audio, a still-picture data compression method when the data is still pictures, an animation data compression method when the data is animation, a text data compression display method when the data is text data, a game data method when the data is game data, an electronic program guide method when the data is electronic program guide data, a graphic method when the data is graphic, a three-dimensional video data method when the data is three-dimensional video data, and a stream mode, and whether the related information other than broadcast is ordinary Internet data or streaming data or other data; genre and contents information, thumbnail information, resume marker information, protect information, temporary delete information, bookmark information, playlist information, still-picture reproduction time information, synchronous audio information, audio dubbing information; and header length and data length.

A 42nd aspect of the present invention provides the broadcast video/audio data recording apparatus according to the 41st aspect, characterized in that the header information is added with all or part of: a flag which indicates whether the data broadcast transmission method is a data carousel mode, or an event message transmission mode, or a mode including the both; a flag which indicates, in case of data carousel broadcast, whether the mode is for recording all the data or for recording only updated data; a flag which indicates whether the automatic update of old data with new data is set OFF or ON in broadcast of updatable data such as news, weather forecast, and stock information; a flag which indicates whether or not the latest data update start time and end time, and a time map exist; and a flag which indicates whether the stream is an ordinary broadcast stream or a server-type broadcast stream.

A 43rd aspect of the present invention provides the broadcast video/audio data recording apparatus according to the 41st aspect, characterized in that it is indicated which the animated picture data compression method is, MPEG video, or H.264 video, or Windows (registered trademark) Media video, which the audio data compression method is, MPEG audio, or Dolby audio, or DTS audio, and which the still-picture data compression method is, JPEG or PNG.

A 44th aspect of the present invention provides the broadcast video/audio data recording apparatus according to the 33rd aspect, characterized in that the header information for the data recorded in the files in the subsidiary file, namely the animated pictures, audios, still pictures, animation, text data, game data, electronic program guide data, graphic, and three-dimensional video data are integrated into total header information and recorded in the subsidiary file.

A 45th aspect of the present invention provides the broadcast video/audio data recording apparatus according to the 44th aspect, characterized in that the total header information includes all or part of the header information described in the 41st aspect.

A 46th aspect of the present invention provides a data recording medium recorded using the broadcast video/audio data recording apparatus according to the 33rd aspect.

A 47th aspect of the present invention provides a broadcast video/audio data recording method for storing edited data obtained by editing input broadcast video/audio data in a separate file from the broadcast video/audio data, characterized in that the file for the edited data stores header information for the edited data, together with the edited data.

A 48th aspect of the present invention provides the broadcast video/audio data recording method according to the 47th aspect, characterized in that the header information is for at least one of animated pictures, audio, still pictures, animation, text data, game data, electronic program guide data, graphic, and three-dimensional video data.

A 49th aspect of the present invention provides the broadcast video/audio data recording method according to the 47th aspect, characterized in that the header information is assigned to and represents each of combinations of data obtained by combining animated pictures having a same encoding format, audios having a same encoding format, still pictures having a same encoding format, animations having a same encoding format, text data having a same encoding format, game data having a same encoding format, and electronic program guide data having a same encoding format, graphic having a encoding format, and three-dimensional video data having a same encoding format.

A 50th aspect of the present invention provides the broadcast video/audio data recording method according to the 47th aspect, characterized in that the header information includes at least some of: a flag indicating whether ordinary digital broadcast without data broadcast, ordinary digital broadcast with program-link-type data broadcast, independent-type data broadcast, audio or radio broadcast, text broadcast, analog broadcast, or related information other than broadcast is recorded or not; a flag indicating whether the recorded broadcast data or related information other than broadcast has been directly recorded or copied or moved from another file; a flag which indicates whether there is a source when the data has been copied or moved,; a file name, a source stream name, and a source stream number when there is a source; a flag which indicates which type of data the source data is when the data has been copied or moved and the source is known, and otherwise indicates which type of data the recorded data is, among animated picture, audio, still pictures, animation, text data, game data, electronic program guide data, graphic, and three-dimensional video data; a flag which indicates an animated picture data compression method when the data is animated pictures, an audio data compression method when the data is audio, a still-picture data compression method when the data is still pictures, an animation data compression method when the data is animation, a text data compression display method when the data is text data, a game data method when the data is game data, an electronic program guide method when the data is electronic program guide data, a graphic method when the data is graphic, a three-dimensional video data method when the data is three-dimensional video data, and a stream mode, and whether the related information other than broadcast is ordinary Internet data or streaming data or other data; genre and contents information, thumbnail information, resume marker information, protect information, temporary delete information, bookmark information, playlist information, still-picture reproduction time information, synchronous audio information, audio dubbing information; and header length and data length.

A 51st aspect of the present invention provides the broadcast video/audio data recording method according to the 50th aspect, characterized in that the header information is added with all or part of: a flag which indicates whether the data broadcast transmission method is a data carousel mode, or an event message transmission mode, or a mode including the both; a flag which indicates, in case of data carousel broadcast, whether the mode is for recording all the data or for recording only updated data; a flag which indicates whether the automatic update of old data with new data is set OFF or ON in broadcast of updatable data such as news, weather forecast, and stock information; a flag which indicates whether or not the latest data update start time and end time, and a time map exist; and a flag which indicates whether the stream is an ordinary broadcast stream or a server-type broadcast stream.

A 52nd aspect of the present invention provides a broadcast video/audio data recording method characterized in that input broadcast video/audio data is converted into a format that can be reproduced with a reproducing apparatus for reproducing the broadcast video/audio data, and then recorded in the converted format.

A 53rd aspect of the present invention provides a data recording medium recording data that is recorded by the broadcast video/audio data recording method according to the 47th aspect.

A 54th aspect of the present invention provides a data recording apparatus for recording data by the broadcast video/audio data recording method according to the 47th aspect.

A 55th aspect of the present invention provides a data reproducing apparatus for reproducing data by the broadcast video/audio data recording method according to the 47th aspect.

### BRIEF DESCRIPTION OF THE DRAWINGS

FIG. 1 is a block diagram showing general configuration of a data recording/reproducing apparatus for performing data broadcast recording according to the present invention;

FIG. 2 is a block diagram specifically showing a section for reproducing and outputting data broadcast, audio broadcast, and Internet additional information according to the present invention;

FIG. 3 is a block diagram for explaining a recording method according to an embodiment of the present invention, showing an example in which management data is recorded in a first file, time map data is recorded in another file, digital broadcast is recorded in a second file, video/audio data of analog broadcast is recorded in a third file, and part of the broadcast video/audio data recorded in the second or third file is copied in a fourth file;

FIG. 4 is a diagram for explaining a recording method according to another embodiment of the present invention, showing an example in which management data is recorded in a first file, time map data is recorded in another file, digital broadcast is recorded in a second file, video/audio data of analog broadcast is recorded in a third file, and part of the broadcast video/audio data recorded in the second or third file is copied in fourth and subsequent similar files;

FIG. 5 is a diagram for explaining a recording method according to still another embodiment of the present invention, showing an example in which management data is recorded in a first file, time map data is recorded in another file, ordinary digital broadcast, ordinary broadcast with link-type data broadcast, independent-type data broadcast, and audio broadcast are recorded in a second file, video/audio data of analog broadcast is recorded in a third file, and then part of the independent-type data broadcast and part of the video/audio data of the analog broadcast are copied into a fourth file;

FIG. 6 is a diagram for explaining a recording method according to still another embodiment of the present invention, showing an example in which management data is recorded in a first file, time map data is recorded in another file, ordinary digital broadcast, ordinary broadcast with link-type data broadcast, independent-type data broadcast, and audio broadcast are recorded in a second file, video/audio data of analog broadcast is recorded in a third file, and then part of the link-type data broadcast and part of the video/audio data of the analog broadcast are copied into fourth and subsequent similar files, respectively;

FIG. 7 is a diagram for explaining a recording method according to still another embodiment of the present invention, showing an example in which management data is recorded in a first file, time map data is recorded in another file, ordinary digital broadcast, ordinary broadcast with link-type data broadcast, independent-type data broadcast, and audio broadcast are recorded in a second file, video/audio data of analog broadcast is recorded in a third file, independent-type data broadcast and audio broadcast are recorded in a fourth file, and then part of the link-type data broadcast and part of the video/audio data of the analog broadcast are copied into a fourth file;

FIG. 8 is a diagram for explaining a recording method according to still another embodiment of the present invention, showing an example in which management data is recorded in a first file, time map data is recorded in another file, ordinary digital broadcast, ordinary broadcast with link-type data broadcast, independent-type data broadcast, and audio broadcast are recorded in a second file, video/audio data of analog broadcast is recorded in a third file, independent-type data broadcast and audio broadcast are recorded in a fourth file, and then part of the link-type data broadcast, part of the video/audio data of the analog broadcast, and part of the independent-type data broadcast are copied in fifth and subsequent similar files, respectively;

FIG. 9 is a diagram showing an example in which digital broadcast is recorded in a second file, and format-converted digital broadcast or analog broadcast is recorded in a third file;

FIG. 10 is a diagram showing an example in which digital broadcast or format-converted analog broadcast or a third file is recorded in a second file, and analog broadcast or format-converted digital broadcast or the second file is recorded in a third file;

FIG. 11 is a diagram showing an example in which data is copied or moved between second, third, and fourth files while converting formats;

FIG. 12 is a diagram for explaining a recording method according to still another embodiment of the present invention, showing an example in which management data is recorded in a first file, time map data is recorded in another file, ordinary digital broadcast, ordinary broadcast with link-type data broadcast, independent-type data broadcast, and audio broadcast are recorded in a second file, video/audio data of analog broadcast is recorded in a third file, and broadcast-related Internet related information are recorded in a fourth file;

FIG. 13 is a diagram for explaining a recording method according to still another embodiment of the present invention, showing an example in which management data is recorded in a first file, time map data is recorded in another file, ordinary digital broadcast, ordinary broadcast with link-type data broadcast, independent-type data broadcast, and audio broadcast are recorded in a second file, video/audio data of analog broadcast is recorded in a third file, broadcast-related Internet related information are recorded in a fourth file, and then part of the second and third files is copied in a fourth file;

FIG. 14 is a diagram for explaining a recording method according to still another embodiment of the present invention, showing an example in which management data is recorded in a first file, time map data is recorded in another file, ordinary digital broadcast and ordinary broadcast with link-type data broadcast are recorded in a second file, video/audio data of analog broadcast is recorded in a third file, independent-type data broadcast and audio broadcast are recorded in a fourth file, broadcast-related Internet related information is recorded in a fifth file, and then part of the second, third, and fourth files is copied in the fifth file;

FIG. 15 is a diagram showing part of an example of DVD_HDVR file structure used in the present invention;

FIG. 16 is a diagram showing another part of the example of DVD_HDVR file structure used in the present invention;

FIG. 17 is a diagram showing still another part of the example of DVD_HDVR file structure used in the present invention;

FIG. 18 is a diagram showing still another part of the example of DVD₁₃ HDVR file structure used in the present invention;

FIG. 19 is a diagram showing still another part of the example of DVD_HDVR file structure used in the present invention;

FIG. 20 is a diagram showing still another part of the example of DVD_HDVR file structure used in the present invention;

FIG. 21 is a diagram showing still another part of the example of DVD_HDVR file structure used in the present invention;

FIG. 22 is a diagram showing still another part of the example of DVD_HDVR file structure used in the present invention;

FIG. 23 is a diagram showing still another part of the example of DVD_HDVR file structure used in the present invention; and

FIG. 24 is a diagram showing an example of a HR_EXTBC.DAT file having header information and total header information.

### BEST MODE FOR CARRYING OUT THE INVENTION

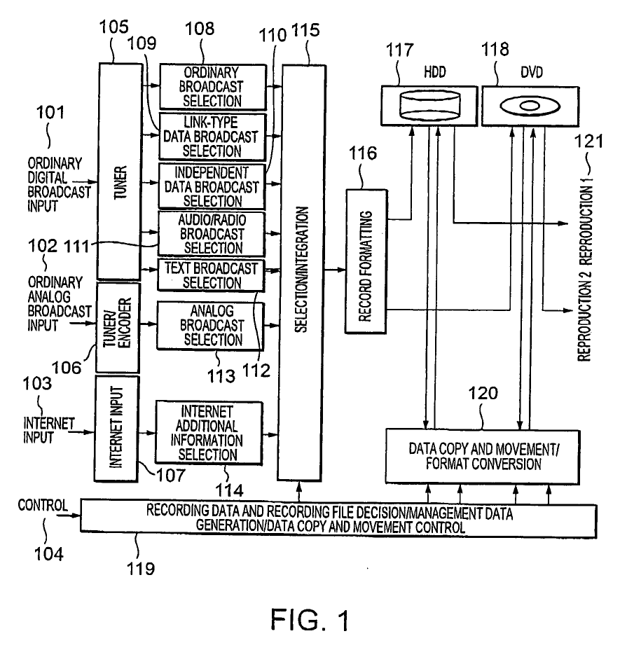

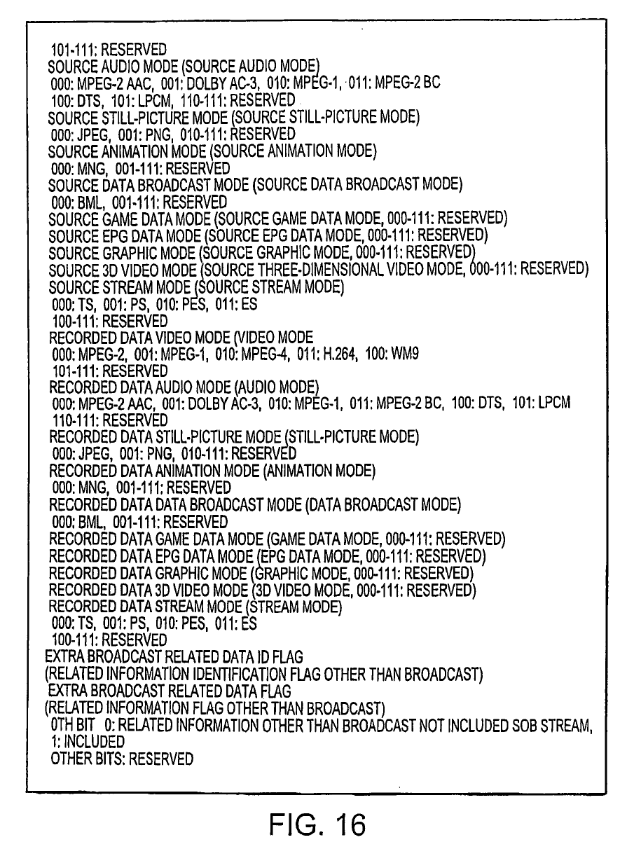

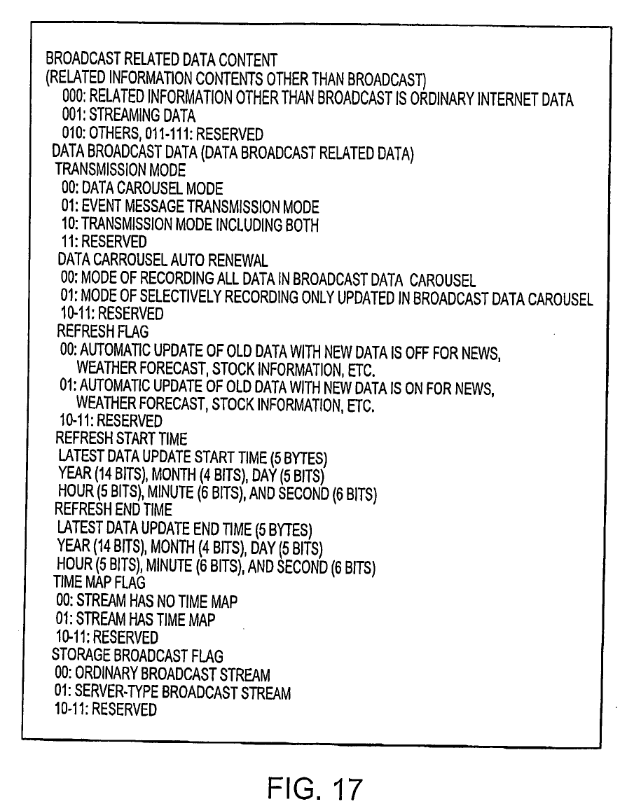

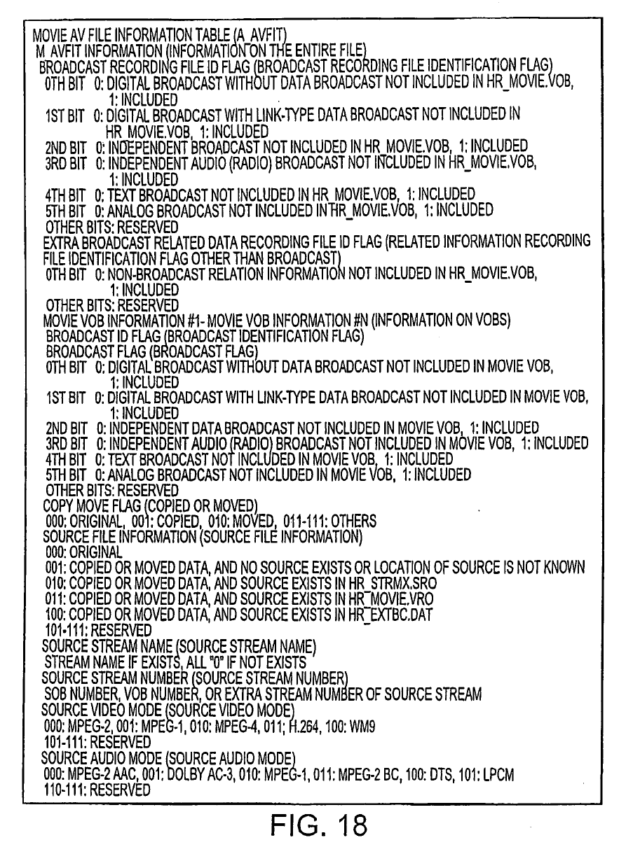

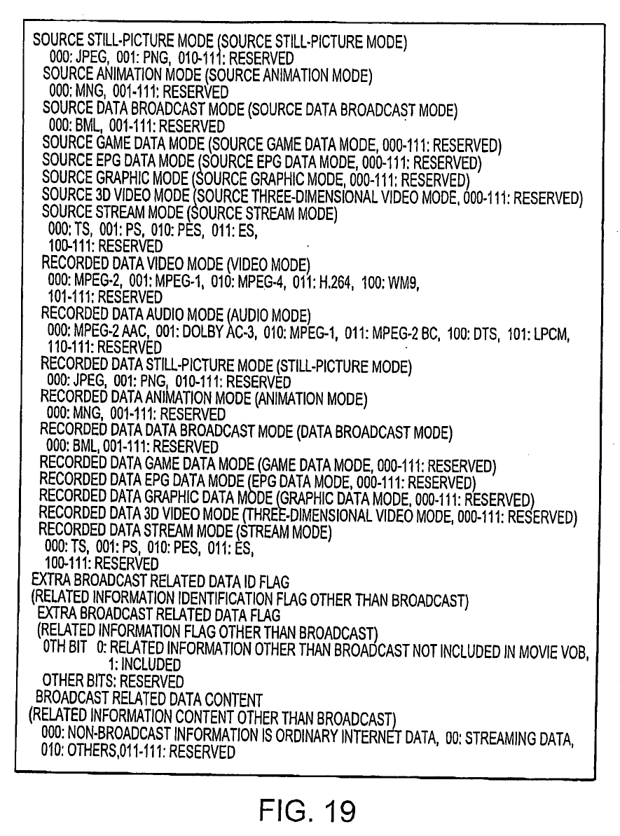

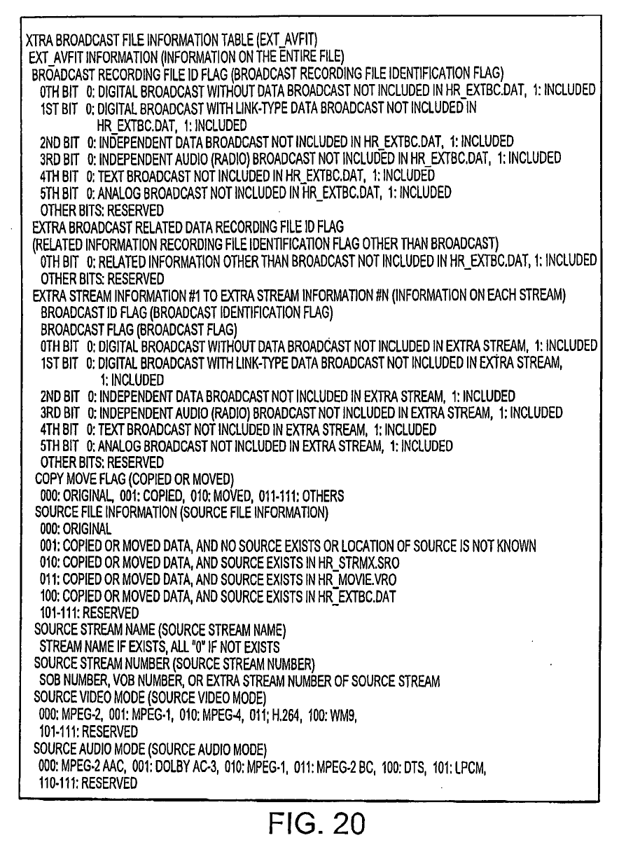

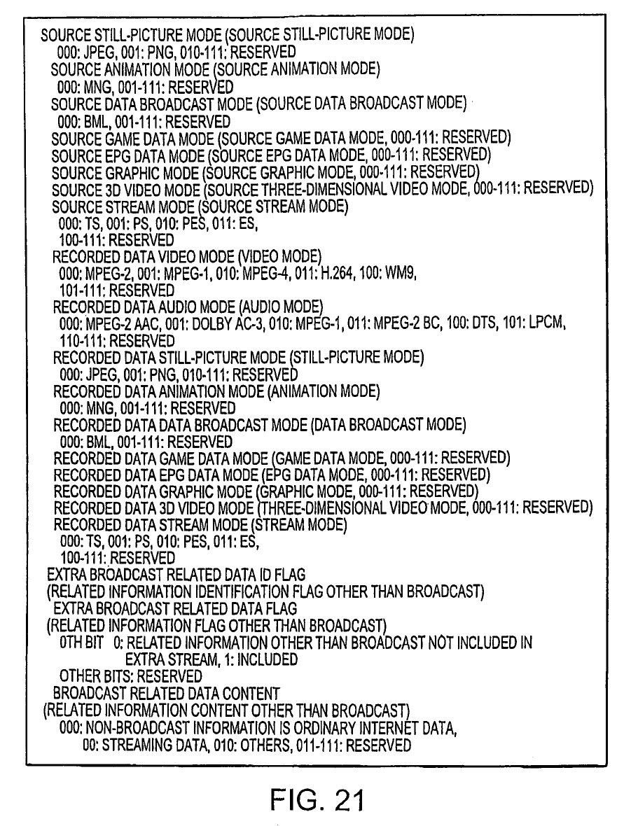

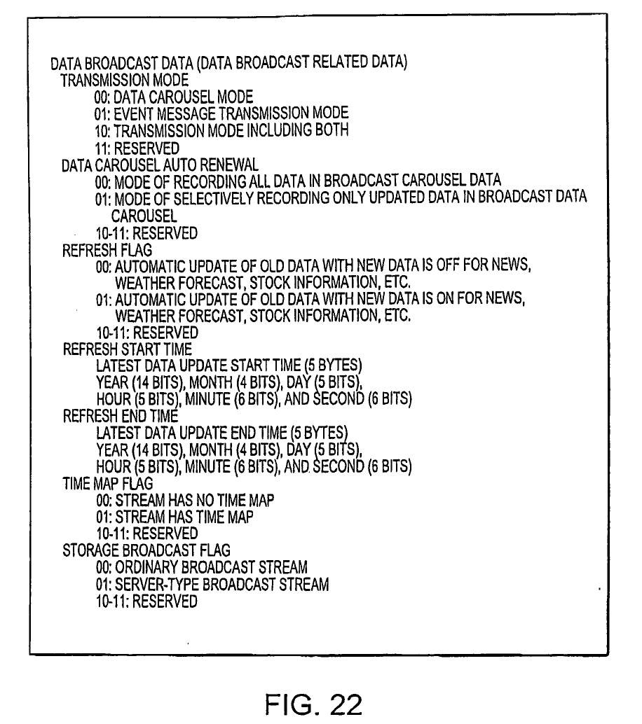

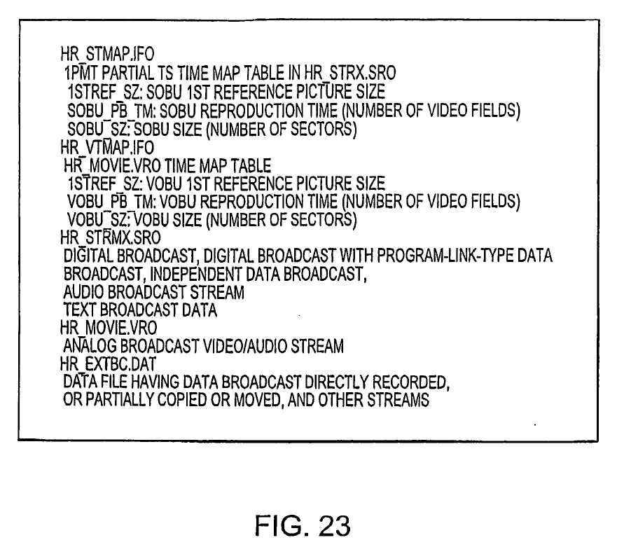

Embodiments of the present invention will be described with reference to FIGS. 1 to 23, and FIG. 24.

FIG. 1 shows a broadcast video/audio data recording/reproducing apparatus for recording broadcast video/audio data according to the present invention. FIG. 1 shows the blocks in the apparatus as being embodied by software, but they may be embodied by hardware.

FIG. 1 shows an example in which ordinary digital broadcast, data broadcast, audio broadcast, text broadcast, analog broadcast, Internet additional information are recorded on a HDD or DVD video recorder.

A ordinary digital broadcast wave is input from 101. The ordinary digital broadcast wave then contains all or part of ordinary broadcast without any accompanying data broadcast, ordinary broadcast with accompanying or link-type data broadcast, independent-type data broadcast, audio broadcast, and text broadcast. All these broadcasts are carried out in the form of TS (Transport Stream).

On the other hand, an analog broadcast wave is input from 102. The analog broadcast wave is supplied to a tuner/encoder 106 as ordinary broadcast. The tuner/encoder 106 demodulates and encodes the analog broadcast, and outputs the same in the form of PS (Program Stream).

Internet additional information as an example of related information other than broadcast is input from 103. The Internet additional information is composed of broadcast-related Internet information, program additional information, director's cut information, directors comment information, E-commerce information, chat information, prior notice information, and the Like. These are basically not given in the form of TS, but may be given in the form of TS.

A control signal 104 is also input. The control signal 104 is a signal to designate a recording method and a type of information to be recorded from among ordinary digital broadcast data broadcast, audio broadcast, text broadcast, analog broadcast, Internet additional information, and the Like. The control signal 104 is a user operation signal given by a user. The digital broadcast wave, the analog broadcast wave, the Internet additional information, and the control signal 104 may be input simultaneously or individually.

The ordinary digital broadcast input 101 is demodulated by a tuner 105. Ordinary broadcast without accompanying data broadcast is selected by an ordinary broadcast selection block 108, ordinary broadcast with accompanying or link-type data broadcast is selected by a Link-type data broadcast selection block 109, independent-type data broadcast is selected by an independent-type data broadcast selection block 110, audio broadcast is selected by an audio broadcast selection block 111, and text broadcast is selected by a text broadcast selection block 112. These are output to a selection/integration block 115.

The analog broadcast input 102 is demodulated and is subjected MPEG encoding by the tuner/encoder 106 and output to the selection/integration block 115.

Necessary information in the Internet input 103 is decoded by an Internet input block 107. Internet additional information is selected by an Internet additional information selection block 114 and output to the selection/integration block 115.

The integration/selection block 115 selects one or more data to be recorded from among the data 108, 109, 110, 111, 112, 113, and 114, integrates them, and outputs the integrated data to a record formatting block 116.

The record formatting block 116 performs formatting operation in relation to recording data input from the selection/integration block 115 and designates a recording file. The record formatting block 116 also generates management data according to the type of the data to be recorded, based on the control signal 104, and records the same on a HDD 117 and a DVD 118 as a dedicated management data file or time map data file. The structure of the recording file will be described in detail later. According to this embodiment, the management data according to the control signal which is generated as a user operation signal is recorded on the HDD 117 or the DVD 118.

The HDD 117 and the DVD 118 denote a hard disk and an optical disk recording medium, respectively.

A data copy/move block 120 is a block where the digital broadcast data, the data broadcast, the audio broadcast, the text broadcast, the analog broadcast data, or the data of the Internet additional information recorded on the HDD 117 or the DVD 118 is copied or moved to another file, or another group. Particulars and processing steps of the data copy/move block wilt be described in detail later.

The control input 104 is used by a block for recorded data and recording file decision, management data generation, and data copy/move control 119 to designate which data is selected and integrated in the selection/integration block 115, and what format the data is converted to by the record formatting block 116, to designate a recording format and a recording file, to generate management data for the selected and integrated data, and records the data on a HDD 117 and a DVD 118 as a dedicated management data file or time map data file. The structure of the recording file will be described later in detail. At the same time, a method and contents of data copy/move, and format conversion are designated to a block for data copy/move and format conversion 120.

Particulars and processing steps of the format conversion will be described in detail later.

The data recorded on the HDD 117 and the DVD 118 is dubbed between them and reproduced through 121. As shown in FIG. 1, the reproduction may be performed from the HDD as reproduction 1, and from the DVD as reproduction 2. Further, although not shown, either the reproduction 1 or the reproduction 2 may be selected by a selector and reproduced through a single channel. The control block 119, which records data on the HDD 117 and the DVD 118 and reproduces the data recorded on the HDD 117 and the DVD 118 in response to the control input 104, operates as data recording means and data reproducing means.

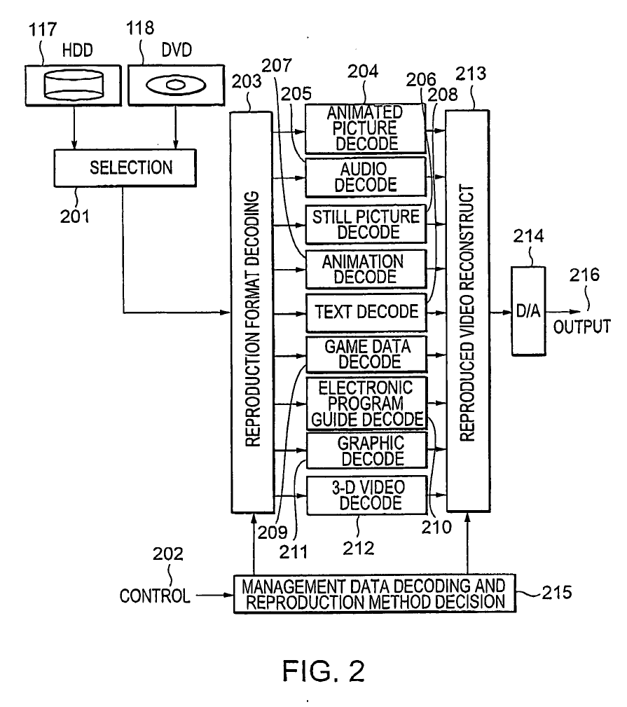

FIG. 2 shows a block diagram for reproducing and outputting ordinary digital broadcast, data broadcast, audio broadcast, text broadcast, analog broadcast, and Internet additional information.

Signals reproduced from the HDD 117 and the DVD 118 are selected by a selection block 201 and input to a reproduction format decoding block 203.

At the same time, a control signal 202 is input by a users operation. The control signal 202 is a control input for deciding a method of decoding and reproducing management data.

The reproduction format decoding block 203 decodes the format of the signal input from 201. For example, if the format is an MPEG animated picture, the signal is output to an animated picture decode block 204; if MPEG-2 AAC audio, to an audio decode block 205; if a JPEG still picture, to a still-picture decode block 206; if MNG animation, to an animation decode block 207; if text, to a text decode block 208; if game data, to a game data decode block 209, if electronic program data, to an electronic program data decode block 210; if graphic, to a graphic decode block 211; and if three-dimensional video data, to a three-dimensional video decode block 212.

The signals output from reproduction format decoding block 203 are decoded by the animated picture decode block 204, the audio decode block 205, the still-picture decode block 206, the animation decode block 207, the text decode block 208, the game data decode block 209, the electronic program guide data decode block 210, the graphic decode block 211, and the three-dimensional video decode block 212, respectively, in accordance with respective formats and are output to a reproduced video reconstruct block 213.

In the reproduced video reconstruct block 213, a reproduced video signal is reconstructed by overlay or the like from the video, the audio, and the data which have been decoded according to the respective formats, and is digital/analog converted by a D/A converter 214.

The management data decoding and reproduction method decision block 215 performs designation of data to be reproduced and reproduction format decoding control operation in cooperation with the reproduction format decoding block 203. The block 215 also performs control operation to reconstruct reproduced video such as overlay in cooperation with the reproduced video reconstruct block 213.

D/A 214 externally outputs video, audio, and data through 216.

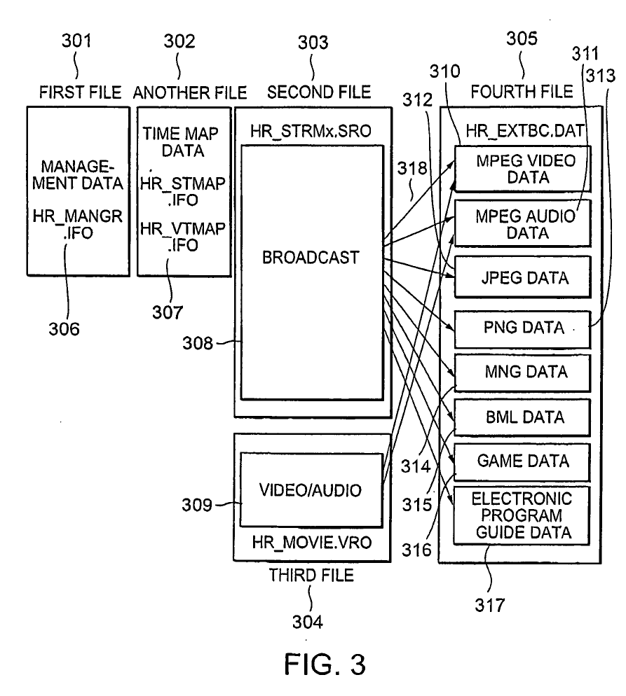

A data broadcast recording method according to the present invention will be described with reference to FIG. 3. In the recording method of the present invention, management data is recorded in a first file while ordinary digital broadcast and data broadcast are recorded together in a second file. In addition, analog broadcast is recorded in a third file. In this recording method, the broadcast data and so on are processed according to the management data, which makes it easy to store and edit the broadcast data and so on.

The data broadcast in the digital broadcast includes program-Link-type data broadcast and independent-type data broadcast.

The program-link-type data broadcast means data broadcast linked with so-called television broadcasting service. For example, such program-link-type data broadcast may be made to correspond to video profiles of players in broadcast of World Cup soccer games, profiles of teams and players, cheer messages, and game results in broadcast of All-Japan High School Baseball Championship at Koshien Stadium.

The independent-type data broadcast means data broadcast in which data such as photographs and text information are broadcast independently of a television program. Such independent-type data broadcast may be made, for example, to correspond to news stories, weather forecast, stock prices, and astrology which are broadcast independently of television programs.

Audio broadcast is one type of the data broadcast. In the audio broadcast, only audio is broadcast.

Text broadcast is another type of the data broadcast. In the text broadcast, only text data is broadcasted.

FIG. 3 shows an example in which management data is recorded in a first file, time map data is recorded in another file, digital broadcast data is recorded in a second file, and analog broadcast data is recorded in a third file, and then part of the digital broadcast data and the analog broadcast data is copied in a fourth file.

In FIG. 3, 301 denotes the first file, 302 denotes the other file, 303 denotes the second file, 304 denotes the third file, and 305 denotes the fourth file.

The first file 301 contains management data 306 (HR_MANGR.IFO). The management data 306 will be described later in detail.

The other file 302 contains time map data 307 (HR_STMAP.IFO, HR_VTMAP.IFO). The time map data 307 is a map indicating the relationship of time and recording position between the second file 303 including 308 and the third file 304 including 309. Although 306 is included in 301 and 307 is included in 302 in FIG. 3, both 306 and 307 may be included in the first file 301. In that case, the other file 302 is not present.

The second file 303 (HR_STRMx.SRO) contains digital broadcast data 308. The digital broadcast data 308 contains not only ordinary digital broadcast but also ordinary broadcast with program-link-type data broadcast, independent-type data broadcast, audio broadcast, text broadcast, and so on.

The third file 304 (HR_MOVIE.VRO) contains video and audio 309 as analog broadcast data.

The fourth file 305 (HR_EXTBC.DAT) is formed by MPEG video data 310, MPEG audio data 311, JPEG data 312, PNG data 313, MNG data 314, BML data 315, game data 316, and electronic program guide data 317. The fourth file 305 may include other types of video/audio data than those described above, such as graphics and three-dimensional video data. The MPEG data 310 and 311 can be an ES or PES stream different from those of the second and third files so as to increase the advantage thereof.

FIG. 3 shows an example in which data is copied by 318 into the MPEG video data 310, the MPEG audio data 311, the JPEG data 312, the PNG data 313, the MNG data 314, the BML data 315, the game data 316, and the electronic program guide data 317 from the data of the digital broadcast 308 recorded in the second file 303, and data is copied by 318 into the MPEG video data 310 and the MPEG audio data 311 from the video/audio data 309 of analog broadcast recorded in the third file 304.

The data in the fourth file 305 can be utilized for other purposes, or stored as an animated picture/audio/still-picture album, or can be independently edited, deleted, processed, or specially reproduced.

Further, the data in the fourth file 305 can be utilized such that animated pictures are retrieved to be recorded as MPEG data, or singing voice data of the user's favorite singers is selectively retrieved to be recorded as Dolby AC-3 data, or the user's favorite animation characters are selectively retrieved to be recorded as animation MNG data.

Although part of the data is retrieved in the example shown here, the entire of the data may be retrieved. Also, instead of being “copied”, the data may be “moved”, involving deletion of the original data from the second or third file. Further, the entire or part of the data may be directly recorded in the fourth file at the same time with broadcasting. The copying or moving of the data is performed by referring to the management data in the first file 301 according to a control signal generated based on the user's operation. This configuration provides an advantage that data broadcast can be managed by referring to the data in the fourth file.

Further, although the example shown here relates to a case in which data is copied or moved from the second or third file to the fourth file, the data may be copied or moved between the second and third files, or from the fourth file to the second or third file. In that case, the format should conform to the format of the file to which the data is copied or moved.

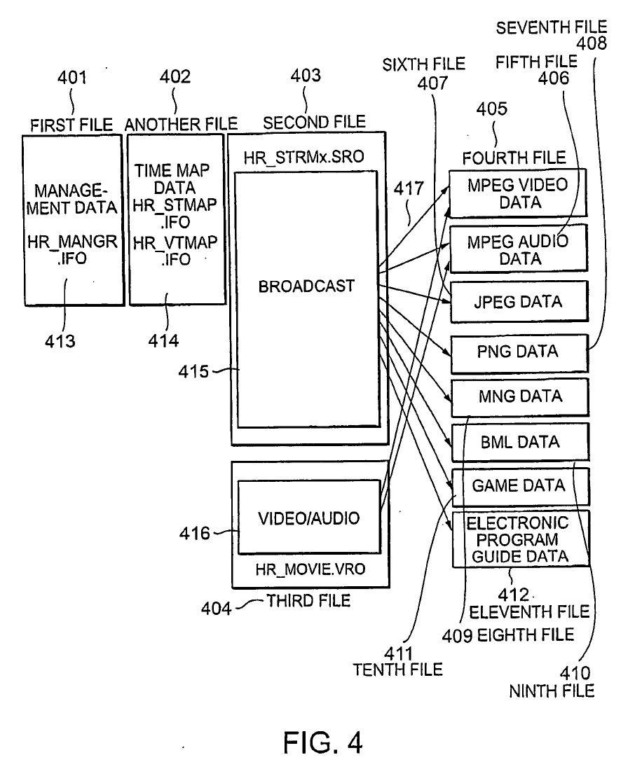

FIG. 4 shows an example in which management data is recorded in a first file, time map data is recorded in another file, digital broadcast data is recorded in a second file, analog broadcast data is recorded in a third file, and then part of the digital broadcast data and the analog broadcast data is copied in fourth and subsequent similar files by combining animated pictures having the same encoding format, audios having the same encoding format, still pictures having the same encoding format, animations having the same encoding format, text data having the same encoding format, game data having the same encoding format, and electronic program guide data having the same encoding format.

In FIG. 4, 401 denotes the first file, 402 denotes the other file, 403 denotes the second file, 404 denotes the third file, 405 denotes the fourth file, 406 denotes the fifth file, 407 denotes the sixth file, 408 denotes the seventh file, 409 denotes the eighth file, 410 denotes the ninth file, 411 denotes the tenth file, and 412 denotes the eleventh file.

The first file 401 contains management data 413. The management data 413 will be described later in detail.

The other file 402 contains time map data 414. The relationship between 402 and 414 is the same as in FIG. 3.

The second file 403 contains digital broadcast data 415. The digital broadcast data 415 contains not only ordinary digital broadcast but also ordinary broadcast with program-link-type data broadcast, independent-type data broadcast, audio broadcast, text broadcast, and so on.

The third file 404 contains video and audio 416 as analog broadcast data.

The fourth file is an MPEG video file 405, the fifth file is an MPEG audio file 406, the sixth file is a JPEG file 407, the seventh file is a PNG file 408, the eighth file is an MNG file 409, the ninth file is a BML file 410, the tenth file is a game data file 411, and the eleventh file is an electronic program guide data file 412. The files 405 to 412 may contain other type of video/audio data than those described above, such as graphic or three-dimensional video data. The MPEG data 405 and 406 can be can be an ES or PES stream different from the second and third files to increase the advantage thereof.

The example shown in FIG. 4 relates to a case in which data is copied by 417 from the data of the digital broadcast 415 recorded in the second file 403 into the MPEG video file 405, the MPEG audio file 406, the JPEG file 407, the PNG file 408, the MNG file 409, the BML file 410, the game data file 411, and the electronic program guide data file 412, and data is copied through 417 from the video/audio data 416 of analog broadcast recorded in the third file 404 into the MPEG video file 405 and the MPEG audio file 406.

The data in the fourth to eleventh files 405 to 412 can be utilized for other purposes or stored as an animated picture/audio/still-picture album, or can be independently edited, deleted, processed, or specially reproduced.

Further, the data in the fourth to eleventh files 405 to 412 can be utilized so that animated pictures are retrieved to be recorded as an MPEG file, or singing voice data of the user's favorite singers is selectively retrieved to be recorded as a Dolby AC-3 file, or the user's animation characters are selectively retrieved to be recorded as animation MNG file.

Although the example herein relates to a case in which part of the data is retrieved, the entire of the data may be retrieved. Also, instead of being “copied”, the data may be “moved”, involving deletion of the original data in the second or third file. Further, the entire or part of the data may be directly recorded in the fourth to eleventh files at the same time with broadcasting. This configuration makes it possible to perform desired data processing by referring to the individual files containing individual data.

Further, although the example shown here relates to a case in which data is copied or moved from the second or third file to the fourth to eleventh files, the data may be copied or moved between the second and third files, or from the fourth to eleventh files to the second or third file. In that case, the format should conform to the format of the file to which the data is copied or moved.

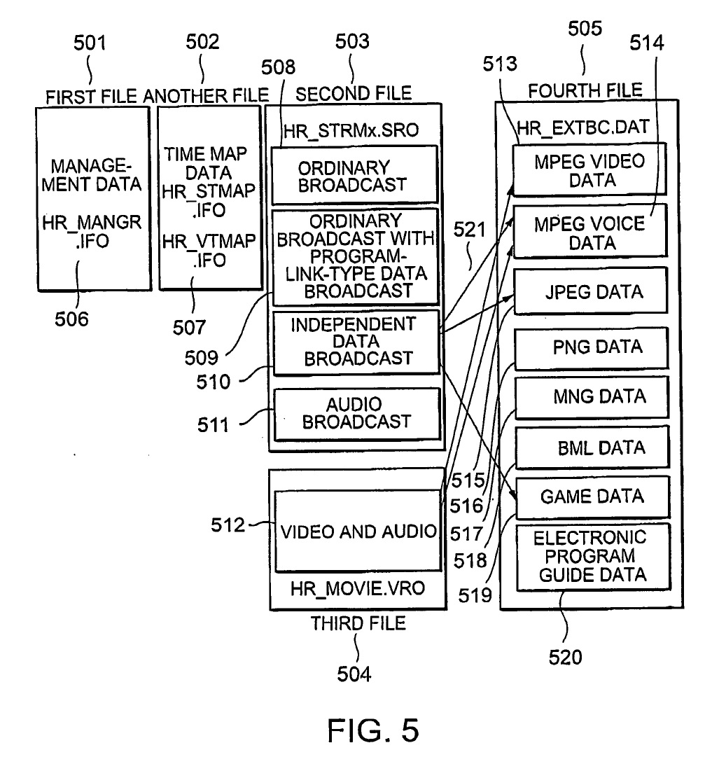

FIG. 5 shows an example in which management data is recorded in a first file, time map data is recorded in another file, ordinary digital broadcast, ordinary broadcast with link-type data broadcast, independent-type data broadcast, and audio broadcast data are recorded in a second file, analog broadcast data is recorded in a third file, and part of the digital broadcast data and the analog broadcast data is copied to a fourth file.

In FIG. 5, 501 denotes the first file, 502 denotes the other file, 503 denotes the second file, 504 denotes the third file, and 505 denotes the fourth file.

The first file 501 contains management data 505. The management data 506 will be described later in detail.

The other file 502 contains time map data 507. The relationship between 502 and 507 is the same as in FIG. 3.

The second file 503 contains ordinary digital broadcast 508, ordinary broadcast with program-link-type data broadcast 509, independent-type data broadcast 510, and audio broadcast 511.

The third file 504 contains video and audio 512 as analog broadcast.

As shown in FIG. 5, the fourth file 505 is composed of MPEG video data 513, MPEG audio data 514, JPEG data 515, PNG data 516, MNG data 517, BML data 518, game data 519, and electronic program guide data 520. The fourth file 505 may contain other types of video/audio data than those described above, such as graphic and three-dimensional video data. The MPEG data 513 and 514 can be can be an ES or PES stream different from the second and third files to increase the advantages.

Here, only a goal scene of sports news reporting a soccer game is retrieved from the independent-type data broadcast 510 recorded in the second file 503, and the data is copied through 521 in the fourth file 505, more specifically in the MPEG audio data 514 as MPEG audio, in the JPEG data 515 as JPEG data, and in the game data 519 as data used in a game.

Also, only a goat scene of sports news reporting a soccer game is retrieved from the video and audio 512 as the analog broadcast recorded in the third file 504 and the data is copied through 521 in the fourth file 505, more specifically in the MPEG animated picture data 513 as MPEG animated picture data, and in the MPEG audio data 514 as MPEG audio data.

These data on “the goal scene in the soccer game” can be utilized for other purposes or stored as an animated picture album or a still-picture album, or can be independently edited, deleted, processed, or specially reproduced.

Although, in the example shown here, part of the data is retrieved, the entire of the data may be retrieved. Also, instead of being “copied”, the data may be “moved”, involving deletion of the original data from the second or third file. Further, the entire or part of the data may be directly recorded in the fourth file at the same time with broadcasting.

Further, although the example shown here relates to a case in which the data is copied or moved from the second and third files to the fourth file, the data may be copied or moved between the second and third files, or from the fourth file to the second or third file. In that case, the format should conform to the format of the file to which the data is copied or moved.

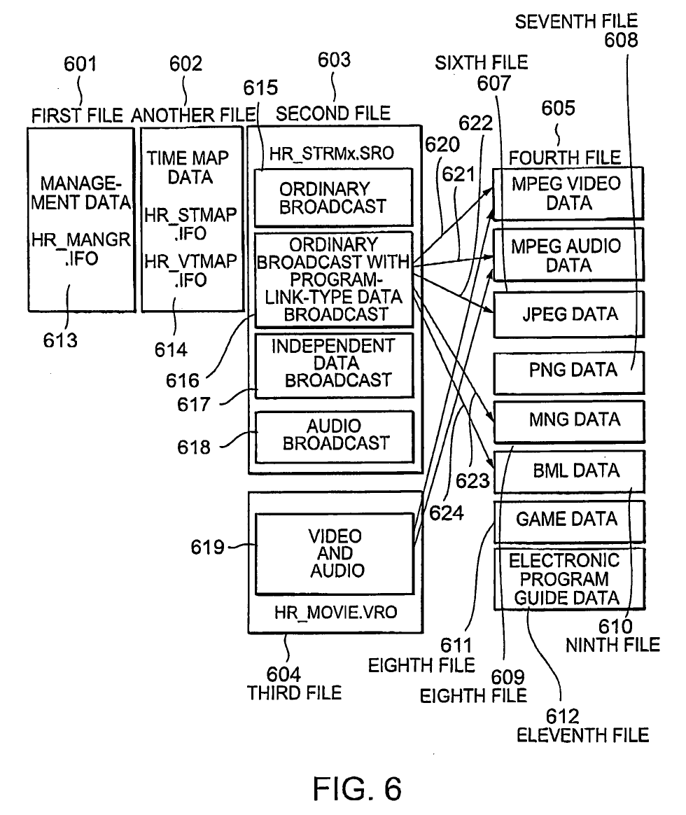

FIG. 6 shows an example in which management data is recorded in a first file, time map data is recorded in another file, ordinary digital broadcast, ordinary broadcast with program-link-type data broadcast, independent-type data broadcast, and audio broadcast data are recorded in a second file, analog broadcast data is recorded in a third file, and then part of the digital broadcast data and the analog broadcast data is copied to fourth and subsequent files by combining animated pictures having a same encoding format, audios having a same encoding format, still pictures having a same encoding format, animations having a same encoding format, text data having a same encoding format, game data having a same encoding format, electronic program guide data having a same encoding format, and placing together the combined pair in the same file.

In FIG. 6, 601 denotes the first file, 602 denotes the other file, 603 denotes the second file, 604 denotes the third file, 605 denotes the fourth file, 606 denotes the fifth file, 607 denotes the sixth file, 608 denotes the seventh file, 609 denotes the eighth file, 610 denotes the ninth file, 611 denotes the tenth file, and 612 denotes the eleventh file.

The first file 601 contains management data 613. The management data 613 will be described in detail later.

The other file 602 contains time map data 614. The relationship between 602 and 614 is the same as in FIG. 3.

The second file 603 contains ordinary digital broadcast 615, ordinary broadcast with program-link-type data broadcast 616, independent-type data broadcast 617, and independent audio broadcast 618, The third file 604 contains video and audio 619 as analog broadcast.

The fourth file is an MPEG video file 605, the fifth file is an MPEG audio file 606, the sixth file is a JPEG file 607, the seventh file is a PNG file 608, the eighth file is an MNG file 609, the ninth file is a BML file 610, the tenth file is a game data file 611, and the eleventh file is an electronic program guide data file 612. The fourth to eleventh files 605 to 612 may contain other types of video/audio data such as graphic and three-dimensional video. The MPEG data 605 and 606 can be can be an ES or PES stream different from the second and third files to increase the advantages thereof.

In this example, singer (animated picture) data 620, song (audio) data 621, costume (still-picture) data 622, character animation of the singer 623, and text data of the singer's profile 624 are retrieved from data of a popular song program, “XXX Singing Contest” recorded in the second file 603 as the program-Link-type data broadcast 616, and copied in the fourth MPEG data file 605 as MPEG data, in the fifth MPEG AAC audio data file 606 as MPEG AAC audio data, in the sixth JPEG data file 607 as JPEG data, in the eighth MNG data file 609 as animation data, and in the ninth BML data file 610 as text data.

Additionally, singer (animated picture) data 625 and song (audio) data 626 are retrieved from the video and audio 619 recorded in the third file 604 as the analog broadcast, and copied in the fourth MPEG data file 605 as MPEG data, and in the fifth MPEG AAC audio data file 606 as MPEG AAC audio data.

These data files 605 to 612 can be utilized for other purposes, or stored as an animated picture/still picture/audio/animation/text data/game data/electronic program guide data album, or can be edited, deleted, processed, or specially reproduced independently and separately.

Although part of the data is retrieved in the example shown here, the entire of the data may be retrieved. Also the data may be “moved” instead of “copied”, involving deletion of the original data from the second or third file. Further, the entire or part of the data may be directly recorded in the fourth to eleventh files at the same time with broadcasting.

Further, although the example shown here relates to a case in which data is copied or moved from the second and third files to the fourth to eleventh files, the data may be copied or moved between the second and the third files, or from the fourth to eleventh files to the second or third file. In that case, the format should conform to the format of the file to which the data is copied or moved.

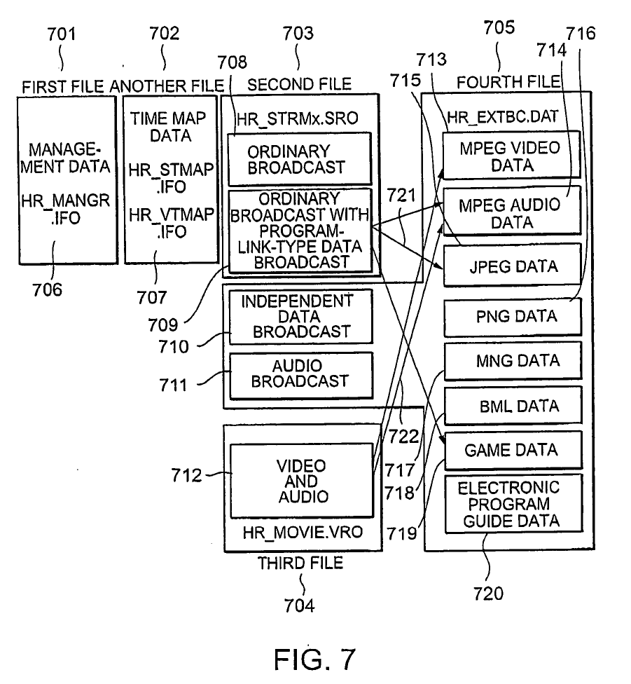

FIG. 7 shows an example in which management data is recorded in a first file, time map data is recorded in another file, ordinary digital broadcast and ordinary broadcast data with link-type data broadcast are recorded in a second file, analog broadcast data is recorded in a third file, independent-type data broadcast and audio broadcast data are recorded in fourth file, and then part of the digital broadcast data and the analog broadcast data is copied in a fourth file.

In FIG. 7, 701 denotes the first file, 702 denotes the other file, 703 denotes the second file, 704 denotes the third file, and 705 denotes the fourth file.

The first file 701 contains management data 706. The management data 706 will be described in detail later.

The other file 702 contains time map data 707. The relationship between 702 and 707 is the same as in FIG. 3.

The second file 703 contains ordinary digital broadcast 708, and ordinary broadcast with program-link-type data broadcast 709.

The third file 704 contains video and audio 712 as the analog broadcast.

As shown in FIG. 7, the fourth file 705 is composed of independent-type data broadcast 710, audio broadcast 711, MPEG video data 713, MPEG audio data 714, JPEG data 715, PNG data 716, MNG data 717, BML data 718, game data 719, and electronic program guide data 720. The fourth file 705 may include other types of video/audio data than those described above, such as graphic and three-dimensional video. The MPEG data 713 and 714 can be an ES or PES stream different from the second and third files, to increase the advantages thereof.

In this example, only a goal scene of sports news reporting a soccer game is retrieved from the ordinary broadcast with program-link-type data broadcast recorded in the second file 703, and the data is copied by 721 in the fourth file 705, more specifically in the MPEG audio data 714 as MPEG audio, in the JPEG data 715 as JPEG data, and in the game data 719 as data used in a game.

Also, only a goal scene of sports news reporting a soccer game is retrieved from the video and audio 712 as the analog broadcast recorded in the third file 704 and the data is copied by 722 in the fourth file 705, more specifically in the MPEG animated picture data 713 as MPEG animated picture data, and in the MPEG audio data 714 as MPEG audio data.

These “soccer goat scene” data can be utilized for other purposes, or stored as an animated picture album or a still-picture album, or can be edited, deleted, processed, or specially reproduced independently and separately.

Although part of the data is retrieved in the example shown here, the entire of the data may be retrieved or the data may be “moved” instead of “copied”, involving deletion of the original data from the second or third file. Further, the entire or part of the data may be directly recorded in the fourth file at the same time with broadcasting.

Although in the example shown here, data is copied or moved from the second and third files to the fourth file, the data may be copied or moved between the second and the third files, or from the fourth file to the second or third file. In that case, the format should conform to the format of the file to which the data is copied or moved.

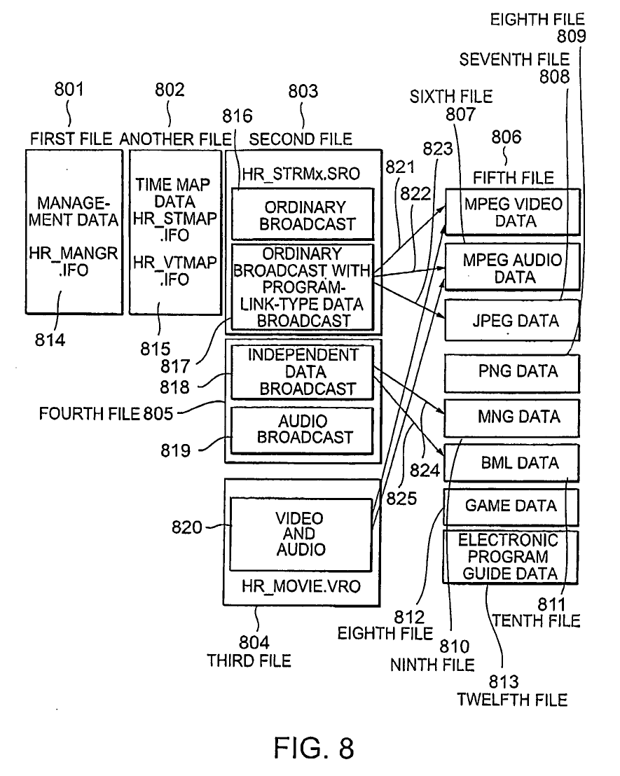

FIG. 8 shows an example in which management data is recorded in a first file, time map data is recorded in another file, ordinary digital broadcast and ordinary broadcast data with program-Link-type data broadcast are recorded in a second file, analog broadcast data is recorded in a third file, independent-type data broadcast and audio broadcast data are recorded in a fourth file, and then part of the digital broadcast data and the analog broadcast data is copied to fifth and subsequent similar files, while combining animated picture s having a same encoding format, audios having a same encoding format, still pictures having a same encoding format, animation having a same encoding format, text data having a same encoding format, game data having a same encoding format, and electronic program guide data having a same encoding format.

In FIG. 8, 801 denotes the first file, 802 denotes the other file, 803 denotes the second file, 804 denotes the third file, 805 denotes the fourth file, 806 denotes the fifth file, 807 denotes the sixth file, 808 denotes the seventh file, 809 denotes the eighth file, 810 denotes the ninth file, 811 denotes the tenth file, 812 denotes the eleventh file, and 813 denotes the twelfth file.

The first file 801 contains management data 814. The management data 814 will be described in detail later.

The other file 802 contains time map data 815. The relationship between 802 and 815 is the same as in FIG. 3.

The second file 803 contains ordinary digital broadcast 816 and ordinary broadcast with program-link-type data broadcast 817.

The third file 804 contains video and audio 820 as the analog broadcast.

The fourth file 805 contains independent-type data broadcast 818 and independent audio broadcast 819.

The fifth file is an MPEG video file 806, the sixth file is an MPEG audio file 807, the seventh file is a JPEG file 808, the eighth file is a PNG file 809, the ninth file is an MNG file 810, the tenth file is a BML file 811, the eleventh file is a game data file 812, and the twelfth file is an electronic program guide data file 813. The fifth to twelfth files 806 to 813 may include other types of video/audio data than those described above, such as graphic and three-dimensional video. The MPEG data 806 and 807 can be can be an ES or PES stream different from the second or third file to increase the advantages thereof.

In this example, singer (animated picture) data 821, song (audio) data 822, and costume (still picture) data 823 are retrieved from data of a popular song program, “XXX Singing Contest” recorded in the second file 803 as the program-link-type data broadcast 817, and copied in the fifth MPEG data file 806 as MPEG data, in the sixth MPEG AAC audio data file 807 as MPEG AAC audio data, and the seventh JPEG data file 808 as JPEG data.

Additionally, singer (animated picture) data 826 and song (audio) data 827 are retrieved from the video and audio 820 recorded in the third file 804 as the analog broadcast, and copied in the fifth MPEG data file 806 as MPEG data, and in the sixth MPEG AAC audio data file 807 as MPEG AAC audio data.

Further, character animation of the singer 824, and text data of the singer's profile 825 are retrieved from data of a popular song program, “XXX Singing Contest” recorded in the fourth file 805 as the independent-type data broadcast 818, and copied in the ninth MNG data file 810 as animation data, and in the tenth BML data file 811 as text data.

These data files 806 to 813 can be utilized for other purposes or stored as an animated picture/still picture/audio/animation/text data/game data/electronic program guide data album, or can be edited, deleted, processed, specially reproduced independently and separately.

Although part of data is retrieved in the example shown here, the entire of the data may be retrieved. Also, the data may be “moved” instead of “copied”, involving deletion of the original data from the second or third file. Further, the entire or part of the data may be directly recorded in the fifth to twelfth file at the same time with broadcasting.

Although the example shown here relates to a case in which data is copied or moved from the second and third files to the fifth to twelfth files, the data may be copied or moved from the fourth file to the fifth to twelfth files, or between the second, third, and fourth files, or from the fifth to eleventh file to the second, third or fourth file. In that case, the format should conform to the format of the file to which the data is copied or moved.

The video/audio data (309, 416, 512, 619, 712, 820) in the third file (304, 404, 504, 604, 704, 804) shown in FIGS. 3 to 8 may be a PS stream obtained by demodulating analog broadcast and MPEG-2 encoding the same as PS.

The video/audio data in the third file shown in FIGS. 3 to 8 may be a format-converted stream obtained by demodulating digital broadcast, and transcoding from TS to PS.

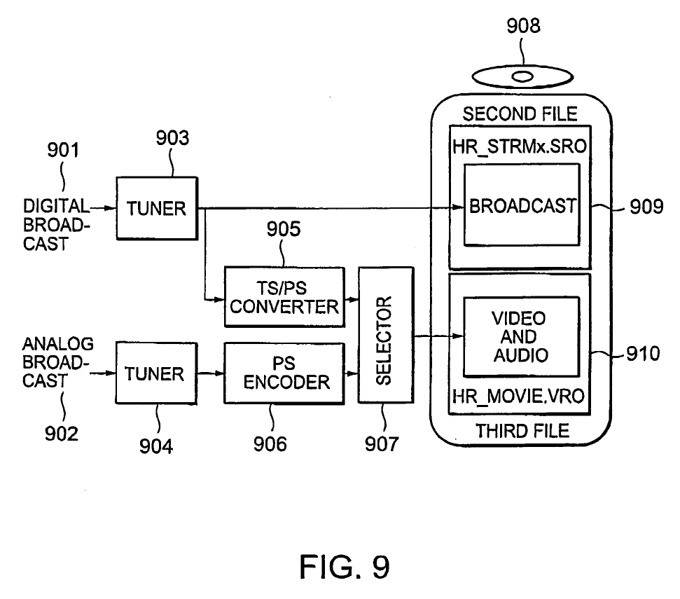

FIG. 9 shows an example of how the video/audio data is recorded in the third file.

Digital broadcast data is input at 901, while analog broadcast data is input at 902.

The input 901 is demodulated by a digital broadcast tuner 903 that is also referred to as a “set-top box”, and recorded directly as TS in a second file 909 in a recording medium 908, while at the same time input to a TS/PS converter 905. It should be noted that overhead addition, management data addition, and recording encoding required for the recording are omitted in this figure.

The TS/PS converter 905 coverts the format of the input from TS to PS, and outputs the PS stream to a selector 907.

On the other hand, the input 902 is demodulated by an analog broadcast tuner 904 and then MPEG-2 encoded by a PS encoder 906 as PS before being input to a selector 907. The selector 907 selects one of the PS stream of the digital broadcast or of the analog broadcast, and the selected stream is recorded in a third file 910 of the recording medium 908.

TS is a transmission method suitable for communication and broadcasting. TS is able to easily record digital broadcast data directly while not so suitable for editing or special reproduction.

PS is suitable for editing and special reproduction of digital broadcast although the digital broadcast must be format-converted from TS, and can be reproduced easily even with a conventional DVD player.

Thus, the digital broadcast data broadcasted in TS can be either TS recorded if it is simply reproduced from record, or PS recorded if it is edited, specially reproduced, or reproduced with another type of DVD player by selecting TS or PS or by making the data recordable both in TS and PS. This provides an advantage of broadening the user's option.

The broadcast stream represented in TS and recorded in the second file may be converted into a video/audio stream represented in PS, which is then recorded in the third file by coping or moving, and the recorded information may be indicated with a broadcast identification flag in the management data.

Further, the video/audio stream represented in TS and recorded in the third file may be converted into a broadcast stream represented in TS, which is then recorded in the second file by coping or moving, and the recorded information may be indicated with a broadcast identification flag in the management data.

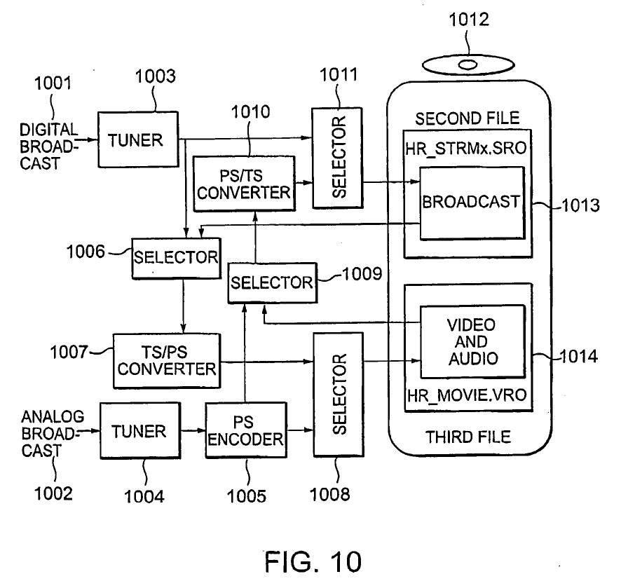

FIG. 10 shows an example in which broadcast video/audio data is recorded in the second or third file.

Digital broadcast data is input at 1001, while analog broadcast data is input at 1002.

The input 1001 is demodulated by a digital broadcast tuner 1003 also referred to as a set-top box, and then input to a selector 1006 or a selector 1011.

On the other hand, the input 1002 is demodulated by an analog broadcast tuner 1004, then MPEG-2 encoded by a PS encoder 1005 as PS and input to a selector 1008 or a selector 1009.

The selector 1006 selects either the received digital broadcast or TS reproduced from a second file 1013 and outputs the selected one to a TS/PS converter 1007. The TS/PS converter 1007 converts the input TS into a PS stream and outputs the PS stream to the selector 1008. The selector 1008 selects a stream of PS-converted digital broadcast and a stream of PS-encoded analog broadcast, and record them as PS in a third file 1014 in a recording medium 1012. It should be noted that overhead addition, management data addition, and recording encoding required for the recording are omitted in this figure.

On the other hand, the selector 1009 selects either the received analog broadcast or PS reproduced from a third file 1014, and outputs the selected on to a PS/TS converter 1010. The PS/TS converter 1010 converts the input PS into a TS stream, and outputs to the selector 1011. The selector 1011 selects a digital broadcast TS stream and a stream of TS encoded analog broadcast, and record them as TS in the second file 1013 in the recording medium 1012.

Thus, the digital broadcast data broadcasted in TS or the PS-encoded analog broadcast data can be TS recorded if it is simply reproduced from record or the recorded data is transmitted, or can be PS recorded if it is edited, specially reproduced, or reproduced with another type of DVD player, by selecting TS or PS, or by making the data recordable both in TS and PS, or by PS/TS converting the PS data and re-recording the converted data. This provides an advantage of broadening the user's option.

Further, when a plurality of time maps cannot be generated simultaneously due to insufficient calculation time during a period of multi-channel recording or the like, the data is temporarily TS recorded in 1013 without time maps, so that the data is retrieved from 1013 to generate time maps while, at the same time, the data is copied or moved to 1014 as PS via the selector 1006, the TS/PS converter 1007, and the selector 1008. This makes it possible to easily perform variable-speed reproduction, time search, and title or chapter search with the use of the time maps.

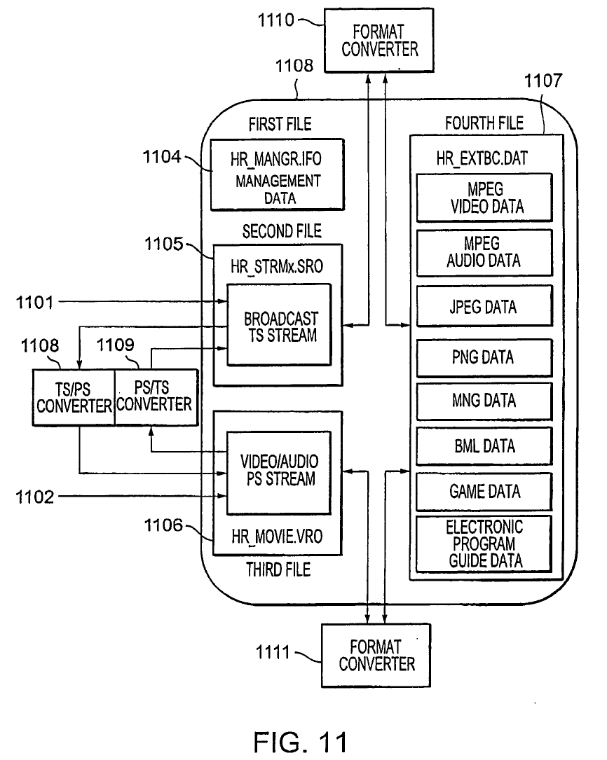

FIG. 11 is a conceptual diagram showing data communication and exchange between the files in the recording medium.

A TS stream is input from 1101 to digital broadcast data, and an MPEG encoded PS stream is input from 1102 to analog broadcast data.

On the other hand, in the recording medium 1103, management data is recorded in a first file 1104, TS broadcast stream data is recorded in a second file 1105, PS video/audio data is recorded in a third file 1106, and the other data is recorded in a fourth file 1107.

In the third file 1106, the data 1102 or a PS stream obtained by converting the second file 1105 by a TS/PS converter 1108 is recorded by coping or moving.

In the second file 1105, the data 1101 or a TS stream obtained by converting the third file 1106 by a PS/TS converter 1109 is recorded by copying or moving.

In the fourth file 1107, data is copied or moved from the second file 1105 or the third file 1106, as MPEG, JPEG, PNG, MNG, BML, game data, and electronic program guide data.

In the second file 1105 or the third file 1106, data is copied or moved from the fourth file 1107, as MPEG TS or MPEG PS.

Management data relating to these copied or moved data are collectively recorded in the first file 1104.

Thus, the user is allowed to store data in an optimal file in an optimal format since the data can be freely copied or moved between the files.

The selection of the files and the formats may be performed by the user or may be performed automatically.

The types of the streams also include a stream having a PS header added to a TS stream, and a stream having a TS header added to a PS stream, and these streams may be either TS streams or PS streams.

Further, when a TS stream is converted into a PS stream, audios having a PS stream format may be added thereto, since the PS stream is used as the global standard. For example, when MPEG-2 AAC audio is recorded as a TS stream, MPEG-1 layer 2 audio in addition to MPEG-2 AAC may be added when the TS stream is converted to a PS stream. In this case, the MPEG-1 layer 2 audio may have a minimum bit rate value for reducing the redundancy, or may even be silent. The same is applicable when a PS stream is converted into a TS stream.

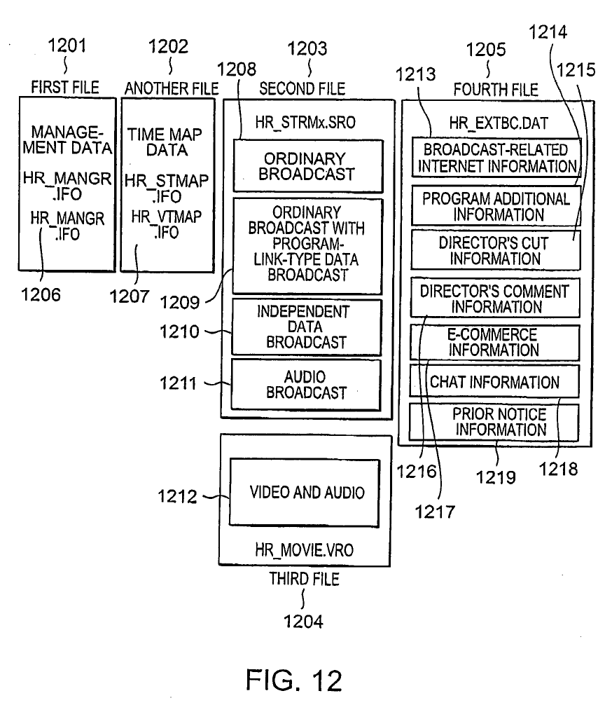

FIG. 12 shows an example in which management data is recorded in a first file, time map data is recorded in another file, ordinary digital broadcast, ordinary broadcast with link-type data broadcast, independent-type data broadcast, and audio broadcast data are recorded in a second file, analog broadcast data is recorded in a third file, and related information other than broadcast such as broadcast-related Internet information, program additional information, directors cut information, director's comment information, E-commerce information, chat information, and prior notice information are recorded in a fourth file.

The related information other than broadcast means data which is not broadcasted but relates to broadcast. The related information other than broadcast may include not only Internet information represented by Internet additional information and Internet broadcast information, but also telephone information, facsimile information, other recording medium information, and other information.

In FIG. 12, 1201 denotes the first file 1202 denotes the other file 1203 denotes the second file 1204 denotes the third file, and 1205 denotes the fourth file.

The first file 1201 contains management data 1206. The management data 1206 will be described in detail later.

The other file 1202 contains time map data 1207. The relationship between 1202 and 1207 is the same as in FIG. 3.

The second file 1203 contains ordinary digital broadcast 1208, ordinary broadcast with program-link-type data broadcast 1209, independent-type data broadcast 1210, and audio broadcast 1211.

The third file 1204 contains video and audio 1212 as analog broadcast.

The fourth file 1205 is composed of broadcast-related Internet information 1213, program additional information 1214, director's cut information 1215, director's comment information 1216, E-commerce information 1217, and chat information 1218, prior notice information 1219. The fourth file 1205 may contain other information relating to Internet.

In FIG. 12, the first file may contain management data, the second file may contain ordinary broadcast, and program-link-type data broadcast, the third file may contain video and audio as analog broadcast, the fourth file may contain independent-type data broadcast and audio broadcast, and the fifth file may contain broadcast-related Internet information, program additional information, director's cut information, director's comment information, E-commerce information, chat information, and prior notice information.

Alternatively, the first file may contain management data, the second file may contain ordinary broadcast and program-link-type data broadcast, the third file may contain video and audio as analog broadcast, the fourth file may contain independent-type data broadcast, audio broadcast, broadcast-related Internet information, program additional information, director's cut information, director's comment information, E-commerce information, chat information, and prior notice information.

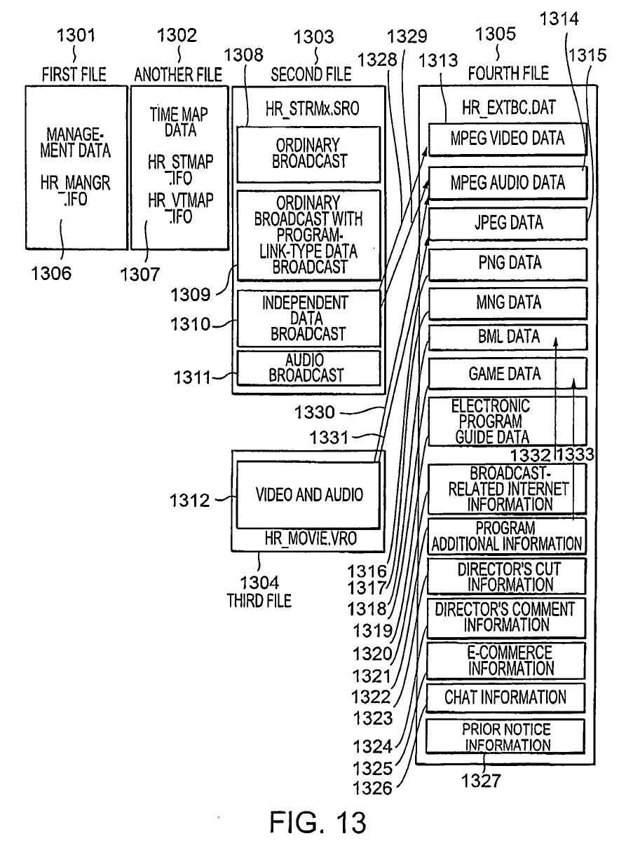

FIG. 13 shows an example in which management data is recorded in a first file, time map data is recorded in another file, ordinary digital broadcast, ordinary broadcast with link-type data broadcast, independent-type data broadcast, and audio broadcast data are recorded in a second file, analog broadcast data is recorded in a third file, broadcast-related Internet information, program additional information, director's cut information, director's comment information, E-commerce information, chat information, and prior notice information are recorded in a fourth file, and then part of the second, the third or the fourth file is copied to the fourth file.

In FIG. 13, 1301 denotes the first file, 1302 denotes the other file, 1303 denotes the second file, 1304 denotes the third file, and 1305 denotes the fourth file.

The first file 1301 contains management data 1306. The management data 1306 will be described in detail later.

The other file 1302 contains time map data 1307. The relationship between 1302 and 1307 is the same as in FIG. 3.

The second file 1303 contains ordinary broadcast 1308, program-link-type data broadcast 1309, independent-type data broadcast 1310, and audio broadcast 1311.

The third file 1304 contains video and audio 1312 as analog broadcast.

The fourth file 1305 is composed of MPEG video data 1313, MPEG audio data 1314, JPEG data 1315, PNG data 1316, MNG data 1317, BML data 1318, game data 1319, electronic program guide data 1320, broadcast-related Internet information 1321, program additional information 1322, director's cut information 1323, directors comment information 1324, E-commerce information 1325, chat information 1326, and prior notice information 1327. The fourth file 1305 may contain other types of video/audio data than those described above, such as graphic and three-dimensional video. The fourth file 1305 further may contain other Internet-related information. The MPEG data 1313 and 1314 can be an ES or PES stream different from the second and third files to increase the advantages.

Animated picture information 1328 and audio information 1329 relating to battle scenes of a movie, “XXX Wars” recorded as independent-type data broadcast 1310 are retrieved from the second file 1303 and copied as MPEG data in the MPEG video data 1313 and the MPEG audio data 1314 in the fourth file 1305, respectively.

Further, weapon-related audio information 1330 and still pictures of weapons 1331 are retrieved from the third file 1304 as video and audio 1312, and copied in MPEG audio data 1314 and JPEG data 1315 in the fourth file 1305, respectively.

Further, battle scene BML information 1332 and weapon-related game data 1333 are retrieved from the Internet information and the program additional information recorded through the Internet in the fourth file 1305, and copied in the BML data 1318 and the game data 1319 in the fourth file 1305, respectively.

The data 1313 to 1320 recorded in this manner can be utilized for other purposes, or stored as an animated picture/audio/still picture/information album, or can be edited, deleted, processed, or specially reproduced independently and separately.

Although part of the data is retrieved in the example shown here, the entire of the data may be retrieved. Also, the data may be “moved” instead of “copied”, involving the deletion of the original data from the second, third, and fourth files. Further, the entire or part of the data may be directly recorded in the fourth file at the same time with broadcasting or Internet delivery.

Further, although the example shown here relates to a case in which the data is copied or moved from the second, third, and fourth files to the fourth file, the data may be copied or moved between the second and third files, or from the fourth file to the second or third file. In that case, the format should conform to the format of the file to which the data is copied or moved.

Although the data 1313 to 1327 are included in the fourth file 1305, the data 1313 to 1320 may be included in the fourth file, while the data 1321 to 1327 may be included in a fifth file.

Further, the data 1313 to 1327 may be separately included in independent files, respectively.

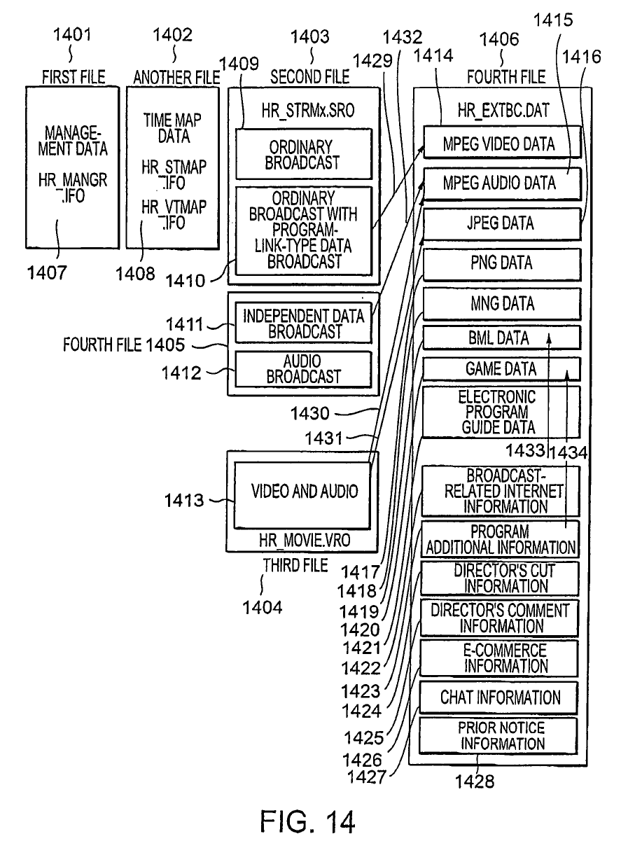

FIG. 14 shows an example in which management data is recorded in a first file, time map data is recorded in another file, ordinary digital broadcast, data of ordinary broadcast with link-type data broadcast is recorded in a second file, analog broadcast data is recorded in a third file, independent-type data broadcast and audio broadcast data are recorded in a fourth file, broadcast-related Internet information, program additional information, director's cut information, director's comment information, E-commerce information, chat information, and prior notice information are recorded in a fifth file, and then part of the second, the third, the fourth or the fifth file is copied to the fifth file.

In FIG. 14, 1401 denotes the first file, 1402 denotes the other file, 1403 denotes the second file, 1404 denotes the third file, 1405 denotes the fourth file, and 1406 denotes the fifth file.

The first file 1401 contains management data 1407. The management data 1407 will be described in detail later.

The other file 1402 contains time map data 1408. The relationship between 1402 and 1408 is the same as in FIG. 3.

The second file 1403 contains ordinary broadcast 1409 and program-link-type data broadcast 1410.

The third file 1404 contains video and audio 1413 as analog broadcast.

The fourth file 1405 contains independent-type data broadcast 1411 and audio broadcast 1412.

The fifth file 1406 is composed of MPEG video data 1414, MPEG audio data 1415, JPEG data 1516, PNG data 1417, MNG data 1418, BML data 1419, game data 1420, electronic program guide data 1421, broadcast-related Internet information 1422, program additional information 1423, director's cut information 1424, director's comment information 1425, E-commerce information 1426, chat information 1427) and prior notice information 1428. The fifth file 1406 may further include other types of video/audio data than those described above, such as graphic and three-dimensional video. Other Internet-related information may be present in the fifth file. The MPEG data 1414 and 1415 can be can be an ES or PES stream different from the second and third files to increase the advantages thereof.

Animated picture information 1429 relating to battle scenes of a movie, “XXX Wars” recorded as program-link-type data broadcast 1410 is retrieved from the second file 1403 and copied as MPEG data in the MPEG video data 1414 in the fifth file 1406.

Further, weapon-related audio information 1430 and still pictures of weapons 1431 are retrieved from the third file 1404 as video and audio 1413, and copied, respectively, in MPEG audio data 1415 and JPEG data 1416 in the fourth file 1305.

Further, audio information 1432 relating to the battle scenes of the movie, “XXX Wars” recorded as the independent-type data broadcast 1411 is retrieved from the fourth file 1405 and copied as MPEG data in the MPEG audio data 1415 in the fifth file 1406.

On the other hand, battle-scene BML information 1433 and weapon-related game data 1434 are retrieved from the Internet information and the program additional information recorded in the fifth file 1406 through Internet, and copied respectively in the BML data 1419 and the game data 1420 in the fifth file 1406.

The data 1414 to 1421 recorded in this manner can be utilized for other purposes, or stored as an animated picture/audio/still-picture/information album, or can be edited, deleted, processed, or specially reproduced independently and separately.

Although part of the data is retrieved in the example shown here, the entire of the data may be retrieved. Also, the data may be “moved” instead of being “copied”, involving the deletion of the original data from the second, third, fourth, and fifth files. Further, the entire or part of the data may be directly recorded in the fifth file at the same time with broadcasting or Internet delivery.

Further, although the example shown here relates to a case in which the data is copied or moved from the second, third, fourth, and fifth files to the fifth file, the data may be copied or moved between the second, third and fourth files, or from the fifth file to the second, the third, or the fourth file. In that case, the format should conform to the format of the file to which the data is copied or moved.

Although the data 1412 and 1413 are included in the fourth file 1405 while the data 1418 to 1428 are included in the fifth file, all of the data 1412 to 1428 may be included in the fourth file.

Alternatively, the data 1412 to 1421 may be included in the fourth file, while the data 1422 to 1428 may be included in the fifth file.

Still alternatively, the data 1412, 1413, and 1422 to 1428 may be included in the fourth file, while the data 1414 to 1421 may be included in the fifth file.

Still alternatively, all of the data 1414 to 1428 may be independent files.

Still alternatively, all of the data 1412 to 142 may be independent files.

In the examples described above, the video data may include both of video data and audio data.

Basically, the stream recorded in the second file is a TS stream, while the streams recorded in the third and subsequent files are not TS streams. However, this rule is not always applicable.

The data broadcast includes program-link-type data broadcast, independent-type data broadcast, audio or radio broadcast, and text broadcast.

As described so far, the program-Link-type data broadcast may be recorded in the second file, and the independent-type data broadcast, the audio or radio broadcast, or the text broadcast may be recorded in the fourth file.

The data to be copied or moved is the entire or part of animated picture data, still-picture data, audio data, animation data, text data, game data, electronic program guide data, graphic data, and three-dimensional video data.

The related information other than broadcast is the entire or part of Internet additional information and Internet broadcast information such as broadcast-related Internet information, program additional information, director's cut information, director's comment information, E-commerce information, chat information, and prior notice information. The Internet broadcast information as used herein refers to streaming video/audio information or the like transmitted through Internet.

Some of the second and subsequent files need not be provided. More specifically, according to the present invention, minimum required are the first file for recording the management data, and a data file for storing, as stored data, at least either the broadcast video/audio data or the recorded broadcast video/audio data obtained by copying or moving. In this case, the data file includes the fourth and subsequent files, in which the stored data described above are recorded in the format corresponding to the management data recorded in the first file. In other words, the recording medium according to the present invention has formats enabling the broadcast video/audio data having mutually different formats to be recorded. In any of the cases, the data stored in the fourth and subsequent files are data obtained by copying, moving, editing, deleting, processing, or specially reproducing the data of other files or the broadcast video/audio data. The data stored in the fourth and subsequent files can be generally referred to as the “edited data”.

A detailed description will be made of the management data indicated by 306 in FIG. 3, 413 in FIG. 4, 506 in FIG. 5, 613 in FIG. 6, 706 in FIG. 7, 814 in FIG. 8, 1206 in FIG. 12, 1306 in FIG. 13, and 1407 in FIG. 14.

There may be recorded in a management file, as the management data, a data broadcast recording file identification flag, a related information recording file identification flag other than broadcast, a data broadcast identification flag, or a related information identification flag other than broadcast.

The broadcast recording file identification flag indicates whether or not ordinary digital broadcast without data broadcast, ordinary digital broadcast with program-link-type data broadcast, independent-type data broadcast, audio or radio broadcast, text broadcast, and analog broadcast are respectively recorded in corresponding files, or indicates the files in which the respective broadcasts are recorded.

The related information recording file identification flag other than broadcast indicates whether or not related information other than broadcast is recorded in the corresponding file, or indicates the file in which the related information other than broadcast is recorded.

The broadcast identification flag indicates whether or not ordinary digital broadcast without data broadcast, ordinary digital broadcast with program-link-type data broadcast, independent-type data broadcast, audio or radio broadcast, text broadcast, and analog broadcast are recorded respectively in the corresponding streams. The broadcast identification flag also indicates whether specific data in the recorded broadcast data and related information other than broadcast has been directly recorded, or has been copied or moved from other files. When the data has been copied or moved, the broadcast identification flag also indicates whether or not a data source exists, and indicates, when the data source exists, its file name, source stream name, and source stream number. The broadcast identification flag further indicates, for the source data and the recorded data when the data has been copied or moved and the source is known, and for the recorded data in other cases, which type the data is of, animated pictures, audio, still pictures, animation, text data, game data, electronic program guide data, graphics, three-dimensional video data, or Internet data. The broadcast identification flag indicates an animated picture data compression method when the data is animated pictures, an audio data compression method when the data is audio, a still-picture data compression method when the data is still pictures, an animation data compression method when the data is animation, a text data compression display method when the data is text data, a game data method when the data is game data, an electronic program guide method when the data is electronic program guide data, a graphic method when the data is graphic, a three-dimensional video data method when the data is three-dimensional video data, as well as a stream format.

The related information identification flag other than broadcast indicates whether or not the related information other than broadcast is recorded in a corresponding stream, and whether the related information other than broadcast is ordinary Internet data or streaming data.

The management file may record a broadcast recording file identification flag, a recording file identification flag for related information other than broadcast, a broadcast identification flag, a related information identification flag other than broadcast, and a flag indicating whether the transmission method of data broadcast is a data carousel mode or an event message transmission mode or a mode including the both. In case of the data carousel broadcast, the management file may further record a flag indicating whether the mode is for recording all the broadcasted data or for recording only the updated data, a flag indicating whether the automatic update of old data with new data is set OFF or ON in the broadcast of updatable data such as news, weather forecast, and stock information, a flag indicating whether or not the latest data update start time and end time and the time map exist, and a flag indicating whether the broadcast is an ordinary broadcast stream or a server-type broadcast stream.

The flag as described above may further indicate which the type of the animated picture data compression method is, MPEG video, H.264 video, or Windows (registered trademark) Media video, which type the audio data compression method is of, MPEG audio, Dolby audio, or DTS audio, and which type the still-picture data compression method is of, JPEG or PNG.

The management file data may record none of those described above, or may record only part of them.

More specific examples will be given below.

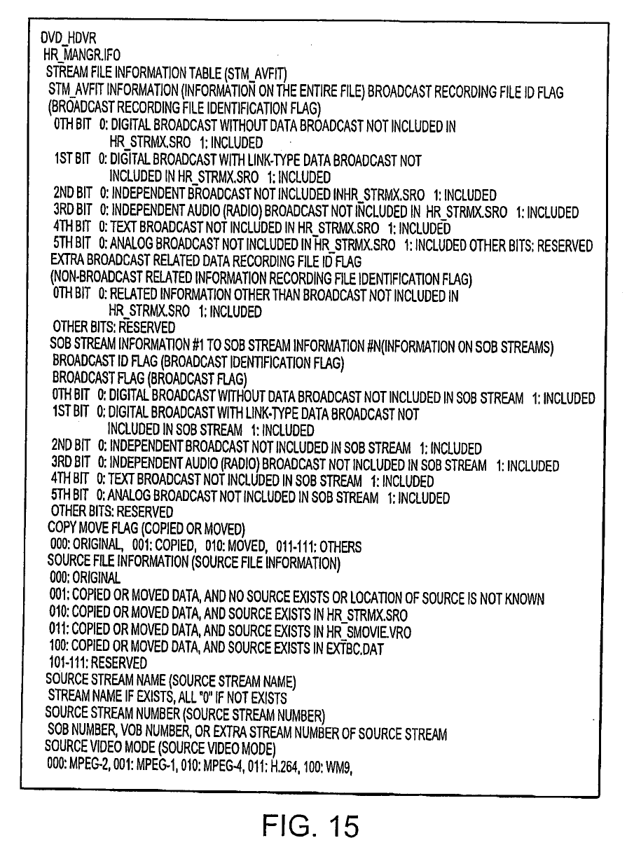

A file structure is shown in FIGS. 15 to 23.

The name of the file as a whole is DVD_HDVR.

DVD_HDVR is composed of files such as HR_MANGR.IFO, HR_STMAP.IFO, HR_VTMAP.IFO, HR_STRMx.SRO, HR_MOVIE.IFO, and HR_EXTBC.DAT. DVD_HDVR need not include all of these files and may include other files such as a backup file referred to as HR_MANGR.BUP.

The management data 306 in FIG. 3, 413 in FIG. 4, 506 in FIG. 5, 613 in FIG. 6, 706 in FIG. 7, 814 in FIG. 8, 1206 in FIG. 12, 1306 in FIG. 13, or 1407 in FIG. 14 corresponds to the HR_MANGR.IFO file.

The HR_MANGR.IFO file is composed of Stream File Information Table (STM_AVFIT), Movie AV File Information Table (M_AVFIT), Extra Broadcast File Information Table (EXT_AVFIT), and other data.

The Stream File Information Table (STM_AVFIT) is composed of STM_AVFIT Information (information on the whole file), SOB Stream Information #1 to SOB Stream Information #n (information on SOB streams), and other data. The SOB Stream Information is generated every time recording is conducted.

STM_AVFIT Information contains the following flags and data.

Broadcast recording file ID flag (broadcast recording file identification flag)

Broadcast recording file ID flag is flag data of six or more bits.

The zeroth bit of “0” indicates that digital broadcast without data broadcast is not included in HR_STRMx.SRO, whereas that of “1” indicates that it is included.

The first bit of “0” indicates that digital broadcast with link-type data broadcast is not included in HR_STRMx.SRO, whereas that of “1” indicates that it is included.

The second bit of “0” indicates that independent data broadcast is not included in HR_STRMx.SRO whereas that of “1” indicates that it is included.

The third bit of “0” indicates that independent audio (radio) broadcast is not included in HR_STRMx.SRO, whereas that of “1” indicates that it is included.

The fourth bit of “0” indicates that text broadcast is not included in HR_STRMx.SRO, whereas that of “1” indicates that it is included.

The fifth bit of “0” indicates that analog broadcast is not included in HR_STRMx.SRO whereas that of “1” indicates that it is included.

The other bits are reserved.

Extra broadcast related data recording file ID flag (related information recording file identification flag other than broadcast)

This is flag data of one or more bits.

The zeroth bit of “0” indicates that related information other than broadcast is not included in HR_STRMx.SRO whereas that of “1” indicates that it is included.

The other bits are reserved.

SOB Stream Information is composed of the following flags and data.

Broadcast ID flag (broadcast identification flag)

Broadcast flag (broadcast flag)

This is flag data composed of 6 or more bits.

The zeroth bit of “0” indicates that digital broadcast without data broadcast is not included in SOB Stream whereas that of “1” indicates that it is included.

The first bit of “0” indicates that digital broadcast with Link-type data broadcast is not included in SOB Stream, whereas that of “1” indicates that it is included.

The second bit of “0” indicates that independent data broadcast is not included in SOB Stream, whereas that of “1” indicates that it is included.

The third bit of “0” indicates that independent audio (radio) broadcast is not included in SOB Stream, whereas that of “1” indicates that it is included.

The fourth bit of “0” indicates that text broadcast is not included in SOB Stream, whereas that of “1” indicates that it is included.

The fifth bit of “0” indicates that analog broadcast is not included in SOB Stream, whereas that of “1” indicates that it is included.

The other bits are reserved.

Copy move flag (copied or moved)

“000” indicates that the data is original, “001” indicates that the data is copied, “010” indicates that the data is moved, and the others are reserved.

Source file information

“000” indicates that the data original.

“001” indicates that the data is copied or moved, and there is no source, or the location of the source is not known.

“010” indicates that the data is copied or moved, and the source is present in HR_STRMx.SRO.

“011” indicates that the data is copied or moved, and the source is present in HR_MOVIE.VRO.

“100” indicates that the data is copied or moved, and the source is present in HR_EXTBC.DAT.

The others are reserved.

Source stream name

Stream name is indicated if source stream name exists, whereas all “0” is indicated if no source stream name exists.

Source stream number

SOB number, VOB number, or Extra Stream number of the source stream.

Source video mode

“000” indicates MPEG-2, “001” indicates MPEG-1, “010” indicates MPEG-4, “011” indicates H.264, “100” indicates WM9, and the others are reserved.

Source audio mode

“000” indicates MPEG-2 AAC, “001 ” indicates Dolby AC-3, “010” indicates MPEG-1, “011 ” indicates MPEG-2 BC, “100” indicates DTS, “101” indicates LPCM, and the others are reserved.

Source still-picture mode

“000” indicates JPEG, “001” indicates PNG, and others are reserved.

Source Animation Mode

“000” indicates MNG, and others are reserved.

Source data broadcast mode

“000” indicates BML, and others are reserved.

Source game data mode (contents are reserved)

Source EPG data mode (contents are reserved)

Source Graphic mode (contents are reserved)

Source 3D video mode (contents are reserved)

Source stream mode

“000” indicates TS, “001” indicates PS, “010” indicates PES, “011” indicates ES, and the others are reserved.

Recorded data video mode (copied/moved data video mode)

“000” indicates MPEG-2, “001” indicates MPEG-1, “010” indicates MPEG-4, “011” indicates H.264, “100” indicates WM9, and the others are reserved.

Recorded data audio mode (copied/moved data audio mode)

“000” indicates MPEG-2 AAC, “001” indicates Dolby AC-3, “010” indicates MPEG-1, “011” indicates MPEG-2 BC, “100” indicates DTS, “101” indicates LPCM, and the others are reserved.

Recorded data still-picture mode (copied/moved data still-picture mode)

“000” indicates JPEG, “001” indicates PNG, and the others are reserved.

Recorded data animation mode (copied/moved data animation mode)

“000” indicates MNG, and the others are reserved.

Recorded data Data broadcast mode (copied/moved data data broadcast mode)

“000” indicates BML, and the others are reserved.

Recorded data Game data mode (copied/moved data game data mode, contents are reserved)

Recorded data EPG data mode (copied/moved data EPG data mode, contents are reserved)

Recorded data Graphic mode (copied/moved data graphic mode, contents are reserved)

Recorded data 3D video mode (copied/moved data three-dimensional video mode, contents are reserved)

Recorded data stream mode (copied/moved data stream mode)

“000” indicates TS, “001” indicates PS, “010” indicates PES, “011” indicates ES, and the others are reserved.

Extra broadcast related data ID flag (related information identification flag other than broadcast)

Extra broadcast related data flag (related information flag other than broadcast)

The zeroth bit of “0” indicates that related information other than broadcast is not included in SOB Stream, whereas that of “1” indicates that it is included. The other bits are reserved.

Broadcast related data content (related information content other than broadcast)

“000” indicates that the related information other than broadcast is ordinary Internet data, “001” indicates that it is streaming data, “010” indicates that it is other data, and the others are reserved.

Data broadcast data (data broadcast related data)

Transmission mode

“00” indicates a data carousel mode, “01” indicates an event message transmission mode, “10” indicates a transmission mode including the both, and the others are reserved.

Data Carousel Auto renewal (data carousel automatic update)

“00” indicates the mode of updating all the broadcast Data Carousel data, “01” indicates the mode of selectively recording only the updated data in the broadcast Data Carousel, and the others are reserved.

Refresh flag (automatic update flag)

“00” indicates that automatic update of old data with new data is OFF, for news, weather forecast, stock information and the like.

“01” indicates that automatic update of old data with new data is ON, for news, weather forecast, stock information, and the Like.

The others are reserved.

Refresh start time (latest data update start time, 5 bytes)

Year (14 bits), month (4 bits), day (5 bits), hour (5 bits), minute (6 bits), and second (6 bits)

Refresh end time (latest data update end time, 5 bytes)

Year (14 bits), month (4 bits), day (5 bits), hour (5 bits), minute (6 bits), and second (6 bits)

Time map flag

“00” indicates that no time map is included in the stream, “01” indicates that a time map is included in the stream, and the others are reserved.

Storage broadcast flag (server-type broadcast flag)

“00” indicates an ordinary broadcast stream, “01” indicates a server-type broadcast stream, and the others are reserved.

Movie AV File Information Table (M_AVFIT) is composed of M_AVFIT Information (information on the whole file), MOVIE VOB Information #1 to MOVIE VOB Information #n (information on VOBs), and other data. The MOVIE VOB Information is generated every time recording is performed.

M_AVFIT Information includes the following flags and data.

Broadcast recording file ID flag (broadcast recording file identification flag)

Extra broadcast related data recording file ID flag (related information recording file identification flag other than broadcast) MOVIE VOB Information is composed of the following flags and data.

Broadcast ID flag (broadcast identification flag)

Broadcast flag

Copy move flag (copied or moved)

Source file information

Source stream name

Source stream number

Source video mode

Source audio mode

Source still-picture mode

Source animation mode

Source data broadcast mode

Source Game data mode

Source EPG data mode

Source Graphic mode

Source 3D video mode (source three-dimensional video mode)

Source stream mode

Recorded data video mode (copied/moved data video mode)

Recorded data audio mode (copied/moved data audio mode)

Recorded data stilt-picture mode (copied/moved data still-picture mode)

Recorded data animation mode (copied/moved data animation mode)

Recorded data Data broadcast mode (copied/moved data data broadcast mode)

Recorded data Game data mode (copied/moved data game data mode)

Recorded data EPG data mode (copied/moved data EPG data mode)

Recorded data Graphic mode (copied/moved data graphic mode)

Recorded data 3D video mode (copied/moved data three-dimensional video mode)

Recorded data stream mode (copied/moved data stream mode)

Extra broadcast related data ID flag (related information identification flag other than broadcast)

Extra broadcast related data flag (related information flag other than broadcast)

Broadcast related data content (related information content other than broadcast)

Here is no Data broadcast data (data broadcast-related data).

Contents of the data are the same as Stream File Information Table (STM_AVFIT), and thus the description thereof will be omitted.

Extra Broadcast File Information Table (EXT_AVFIT) is composed of EXT_AVFIT Information (information on the whole file), EXT Stream Information #1 to EXT Stream Information #n (information on each stream), and other data.

EXT_AVFIT Information includes the following flags and data.

Broadcast recording file ID flag (broadcast recording file identification flag)

Extra broadcast related data recording file ID flag (related information recording file identification flag other than broadcast)

EXT stream Information is composed of the following flags and data.

Broadcast ID flag (broadcast identification flag)

Broadcast flag

Copy move flag (copied or moved)

Source file information

Source stream name

Source stream number

Source video mode

Source audio mode

Source still-picture mode

Source animation mode

Source data broadcast mode

Source Game data mode

Source EPG data mode

Source Graphic mode

Source 3D video mode (source three-dimensional video mode)

Source stream mode

Recorded data video mode (copied/moved data video mode)

Recorded data audio mode (copied/moved data audio mode)

Recorded data still-picture mode (copied/moved data still-picture mode)

Recorded data animation mode (copied/moved data animation mode)

Recorded data Data broadcast mode (copied/moved data data broadcast mode)

Recorded data Game data mode (copied/moved data game data mode)

Recorded data EPG data mode (copied/moved data EPG data mode)

Recorded data Graphic mode (copied/moved data graphic mode)

Recorded data 3D video mode (copied/moved data three-dimensional video mode 7)

Recorded data stream mode (copied/moved data stream mode)

Extra broadcast related data ID flag (related information identification flag other th n broadcast)

Extra broadcast related data flag (related information flag other than broadcast)

Broadcast related data content (related information content other than broadcast)

No Data broadcast data (data broadcast-related data) is included.

Transmission mode

Data Carousel Auto renewal (data carousel automatic update)

Refresh flag (automatic update flag)

Refresh start time (latest data update start time, 5 bytes)

Refresh end time (latest data update end time, 5 bytes)

Time map flag

Storage broadcast flag (server-type broadcast flag)

Contents of the data are the same as Stream File Information Table (STM_AVFIT), and thus the description thereof will be omitted.

HR_STMAP.IFO is a time map table for HR_STRMx.SRO, and is composed of the following;

1STREF_SZ indicating a SOBU first reference picture size;

SOBU_PB_TM indicating SOBU reproduction time (number of video fields); and

SOBU_SZ indicating a SOBU size (number of sectors).

HR_VTMAP.IFO is a time map table for HR_MOVIE.VRO, and is composed of the following:

1STREF_SZ indicating a VOBU first reference picture size;

VOBU_PB_TM indicating VOBU reproduction time (number of video fields); and

VOBU_SZ indicating VOBU size (number of sectors).

HR_STRMx.SRO is a stream data file, and is composed of digital broadcast, digital broadcast with program-Link-type data broadcast, independent-type data broadcast, audio broadcast stream, and text broadcast data.

HR_MOVIE.VR is an animated picture data file, and is composed of an analog broadcast video/audio stream.

HR_EXTBC.DAT is a data file, and is composed of directly recorded data broadcast, or partially copied or moved data file, and other streams.

Using the management data, the broadcast video/audio data is copied in a manner as described below.

The user enters a source file and source stream to copy, a copy destination file, a copy destination stream, and copy start time and end time. Normally, a remote controller or the like is used to designate specific data broadcast contents, a start point, and a finish point.

This control signal is input through the control input 104 shown in FIG. 1, and the block for decision of recorded data and recording file, generation of management data, and control of data copying/moving 120 performs the decision, the generation, and the control.

A description will be made of an example of management data relating to data that is copied to a designated copy destination file according to the copy start time and end time, when the source file is HR_STRMx.SRO, the copy destination file is HR_EXTBC.DAT, the copied data is independent data broadcast, and the stream number is 03H.

The structure of the management data HR_MANGR.IFO is as follows.

STM_AVFIT Information in Stream File Information Table (STM_AVFIT) includes the followings:

Data broadcast recording file ID flag

The zeroth bit of “0”, indicating that digital broadcast without data broadcast is not included in HR_STRMx.SRO;

The first bit of “0”, indicating that digital broadcast with link-type data broadcast is not included in HR_STRMx.SRO;

The second bit of “1”, indicating that independent data broadcast is included in HR_STRMx.SRO;

The third bit of “0”, indicating that independent audio (radio) broadcast is not included in HR_STRMx.SRO;

The fourth bit of “0”, indicating that text broadcast is not included in HR_STRMx.SRO;

The fifth bit of “0”, indicating that analog broadcast is not included in HR_STRMx.SRO.

Extra broadcast related data recording file ID flag (related information recording file identification flag other than broadcast)

The zeroth bit of “0”, indicating that related information other than broadcast is not included in HR_STRMx.SRO.

SOB Stream Information in Stream File Information Table (STM_AVFIT) includes the followings:

Broadcast ID flag

Broadcast flag

The zeroth of 0, indicating that digital broadcast without data broadcast is not included in SOB Stream;

The first bit of “0”, indicating that digital broadcast with link-type data broadcast is not included in SOB Stream

The second bit of “1”, indicating that independent data broadcast is included in SOB Stream

The third bit of “0”, indicating that independent audio (radio) broadcast is not included in SOB Stream

The fourth bit of “0”, indicating that text broadcast is not included in SOB Stream

The fifth bit of “0”, indicating that analog broadcast is not included in SOB Stream

Copy move flag of “001”, indicating “copied”

Source file information of “000”, indicating original

Source stream name of all “0”

Source stream number 03H

Source video mode of “000”, indicating MPEG-2

Source audio mode of “000”, indicating MPEG-2 AAC

Source still-picture mode of “000”, indicating JPEG

Source animation mode of “000”, indicating MNG

Source data broadcast mode of “000”, indicating BML

Source Game data mode of all “0”

Source EPG data mode of all “0”

Source Graphic mode of all “0”

Source 3D video mode of all “0”

Source stream mode of “000”, indicating TS

Recorded data video mode of “000”, indicating MPEG-2

Recorded data audio mode of “000”, indicating MPEG-2 AAC

Recorded data still-picture mode of “000”, indicating JPEG

Recorded data animation mode of “000”, indicating MNG

Recorded data Data broadcast mode of “000”, indicating BML

Recorded data Game data mode of all “0”

Recorded data EPG data mode of all “0”

Recorded data Graphic mode of all “0”

Recorded data 3D video mode of all “0”

Recorded data stream mode of “000”, indicating TS

Extra broadcast related data ID flag

Extra broadcast related data flag

The zeroth bit of “0”, indicating that related information other than broadcast is not included in SOB Stream

Broadcast related data content

“000”, indicating that related information other than broadcast is ordinary Internet data

Data broadcast data

Transmission mode of “00”, indicating the data carousel mode

Data Carousel Auto renewal of “00”, indicating the broadcast data Carousel all data recording mode

Refresh flag of “00”, indicating that the automatic update of old data with new data is OFF

Refresh start time

Year (14 bits), month (4 bits), day (5 bits), hour (5 bits), minute (6 bits), and second (6 bits)

Refresh end time

Year (14 bits), month (4 bits), day (5 bits), hour (5 bits), minute (6 bits), and second (6 bits)

Time map flag of “00”, indicating that the stream has no time map

Storage broadcast flag of “00”, indicating ordinary broadcast stream EXT_AVFIT Information in Extra Broadcast File Information Table (EXT_AVFIT) includes the followings.

Data broadcast recording file ID flag

The zeroth bit of “0”, indicating that digital broadcast without data broadcast is not included in HR_EXTBC.DAT

The first bit of “0”, indicating that digital broadcast with link-type data broadcast is not included in HR_EXTBC.DAT

The second bit of “1”, indicating that independent data broadcast is included in HR_EXTBC.DAT

The third bit of “0”, indicating that independent audio (radio) broadcast is not included in HR_EXTBC.DAT

The fourth bit of “0”, indicating that text broadcast is not included in HR_EXTBC.DAT

The fifth bit of “0”, indicating that analog broadcast is not included in HR_EXTBC.DAT

Extra broadcast related data recording file ID flag (related information recording file identification flag other than broadcast)

The zeroth bit of “0”, indicating that related information other than broadcast is not included in HR_EXTBC.DAT

EXT Stream Information in Extra Broadcast File Information Table (EXT_AVFIT) includes the followings.

Broadcast ID flag

Broadcast flag

The zeroth bit of “0”, indicating that digital broadcast without data broadcast is not included in EXT Stream

The first bit of “0”, indicating that digital broadcast with link-type data broadcast is not included in EXT Stream

The second bit of “1”, indicating that independent data broadcast is included in EXT Stream

The third bit of “0”, indicating that independent audio (radio) broadcast is not included in EXT Stream

The fourth bit of “0”, indicating that text broadcast is not included in EXT Stream

The fifth bit of “0”, indicating that analog broadcast is not included in EXT Stream

Copy move flag of “001”, indicating “copied”

Source file information of “010”, indicating that the data is copied and the source is in HR_STRMx.SRO

Source stream name of all “0”

Source stream number 03H

Source video mode of “000”, indicating MPEG-2

Source audio mode of “000”, indicating MPEG-2 AAC

Source still-picture mode of “000”, indicating JPEG

Source animation mode of “000”, indicating MNG

Source data broadcast mode of “000”, indicating BML

Source Game data mode of all “0”

Source EPG data mode of all “0”

Source Graphic mode of all “0”

Source 3D video mode of all “0”

Source stream mode of “000”, indicating TS

Recorded data video mode of “000”, indicating MPEG-2

Recorded data audio mode of “000”, indicating MPEG-2 AAC

Recorded data still-picture mode of “000”, indicating JPEG

Recorded data animation mode of “000”, indicating MNG

Recorded data Data broadcast mode of “000”, indicating BML

Recorded data Game data mode of all “0”

Recorded data EPG data mode of all “0”

Recorded data Graphic mode of all “0”

Recorded data 3D video mode of all “0”

Recorded data stream mode of “000”, indicating TS

Extra broadcast related data ID flag

Extra broadcast related data flag

The zeroth bit of “0”, indicating that related information other than broadcast is not included EXT Stream

Broadcast related data content

“000”, indicating that related information other than broadcast is ordinary Internet data

Data broadcast data

Transmission mode of “00”, indicating the data carousel mode

Data Carousel Auto renewal of “00”, indicating broadcast data Carousel the whole data recording mode

Refresh flag of “00”, indicating that automatic update of old data with new data is OFF

Refresh start time

Year (14 bits), month (4 bits), day (5 bits), hour (5 bits), minute (6 bits), and second (6 bits)

Refresh end time

Year (14 bits), month (4 bits), day (5 bits), hour (5 bits), minute (6 bits), and second (6 bits)

Time map flag of “00”, indicating that the stream has no time map

Storage broadcast flag of “00”, indicating ordinary broadcast stream

In this manner, the ordinary digital broadcast and the data broadcast are recorded in the second file, the analog broadcast is recorded in the third file, the entire or part of the broadcast video/audio data recorded in the second or third file is copied or moved to the fourth file, and the entire or part of the related information other than broadcast such as broadcast-related Internet information is copied or moved to the fourth file. This makes it possible to record the broadcast video/audio data easily. The recorded broadcast video/audio data can be easily separated from the broadcast to store, edit, delete, process, or specially reproduce the same in a separate file.

The data recorded in the second file is format-converted before being copied or moved to the third file, whereby the data can be reproduced with another DVD player or DVD recorder. The data recorded in the third file is format-converted before being copied or moved to the second file, whereby the data can be transmitted directly.

Further, the digital broadcast is temporarily recorded in the second file without a time map by means of multi-channel recording or the like, and then is copied or moved to the second or third file while computing the time map. Thus, the time map can be added to provide advantages that variable-speed reproduction, time search, and title or chapter search can be performed easily.

The broadcast recording file identification flag and the related information recording file identification flag other than broadcast may be displayed either separately or simultaneously. The broadcast identification flag and the related information identification flag other than broadcast may be displayed either separately or simultaneously.

The data structure, sequence of data arrangement, flag names, number of bits, and assignment of bits of the management data need not be the same as the example described above.

The entire of the management data described above need not be provided, and only part thereof may be provided.

The management data described above may be generated in larger or smaller units.

The start address, the finish address, and the data length of the management data may be recorded as required when the management data is recorded on a recording medium.

It should be noted that the present invention also includes a broadcast video/audio data recording apparatus for recording broadcast video/audio data in the recording method described above, and a broadcast video/audio data reproducing apparatus for reproducing broadcast video/audio data recorded in the recording method described above.

It is obvious that the present invention also includes a recording medium on which data is recorded in the recording method described above. The recording medium according to the present invention may record broadcast video/audio data in a separate region from a region in which management data for managing the broadcast video/audio data.

The data in the fourth and subsequent files, namely, animated picture, audio, still picture, animation, text data, game data, electronic program guide data, graphic, or three-dimensional video data may have header information added thereto.

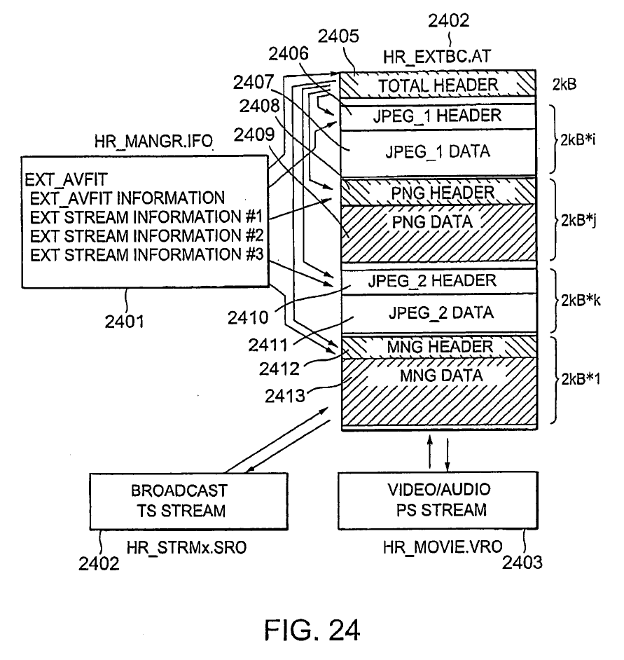

FIG. 24 shows an example in which header information is added to the data.

The reference numeral 2401 denotes a HR_MANGR.IFO file, 2402 denotes a HR_STRMx.SRO file, 2403 denotes a HR_MOVIE.IFO file, and 2404 denotes a HR_EXTBC.DAT file. In the HR_EXTBC.DAT file denoted by 2404, the reference numeral 2405 denotes a total header to be described later, 2406 and 2407 denote a JPEG_{—}1 header and JPEG_{—}1 data, 2408 and 2409 denotes a PNG header and PNG data, 2410 and 2411 denotes a JPEG_{—}2 header and JPEG_{—}2 data, and 2412 and 2413 denotes an MNG header and MNG data.

As seen from the drawing, the headers are arranged at the top of each data, and the total header is arranged at the top of the whole file.

Specifically, the HR_EXTBC.DAT file has a structure as described below.

In this structure, the format data and the total header may be aligned at 2 kB.

| HR_EXTBC.DAT | | |
|---|---|---|
| \|→ | Total header (2kB) | |
| \|→ | JPEG_1 Still picture (2kB*i) | |
| \| | \|→ | JPEG_1 header |
| \| | \|→ | JPEG_1 data |
| \|→ | PNG Still picture (2kB*j) | |
| \| | \|→ | PNG header |
| \| | \|→ | PNG data |
| \|→ | JPEG_2 Still picture (2kB*k) | |
| \| | \|→ | JPEG_2 header |
| \| | \|→ | JPEG_2 data |

| | |
|---|---|
| \|→ | MNG animation (2kB*t) |
| \|→ | MNG header |
| \|→ | MNG data |

In the data in the fourth and subsequent files, the animated pictures recorded in the same format, the audio recorded in the same format, the still pictures recorded in the same format, the animations recorded in the same format, the text data recorded in the same format, the game data recorded in the same format, the electronic program guide data recorded in the same format, graphic recorded in the same format, and the three-dimensional video data recorded in the same format may be compiled together, respectively, and header information may be assigned to the compiled data.

This means that, although not shown in FIG. 24, JPEG_{—}1 and JPEG_{—}2 may be incorporated as a single JPEG data which is composed of a JPEG header and JPEG data.

The header information may contain at least part of the information described below: a flag indicating whether ordinary digital broadcast without data broadcast, ordinary digital broadcast with program-link-type data broadcast, independent-type data broadcast, audio or radio broadcast, text broadcast, analog broadcast, or related information other than broadcast is recorded or not; a flag indicating whether the recorded broadcast data or related information other than broadcast has been directly recorded or has been copied or moved from another file; a flag which indicates, when the data has been copied or moved, whether or not the source exists, and when the source exists, a file name, a source stream name, and a source stream number thereof; a flag which indicates, when the data has been copied or moved and its source is known, which type of data the source data and the recorded data are, and otherwise indicates which type of data the recorded data is, animated pictures, audio, a still pictures, animation, text data, game data, electronic program guide data, graphics, or three-dimensional video data; a flag which indicates an animated picture data compression method when the data is animated pictures, an audio data compression method when the data is audio, a still-picture data compression method when the data is still pictures, an animation data compression method when the data is animation, a text data compression display method when the data is text data, a game data method when the data is game data, an electronic program guide method when the data is electronic program guide data, a graphic method when the data is graphic, a three-dimensional video data method when the data is three-dimensional video data, and a stream mode, and indicates whether the related information other than broadcast is ordinary Internet data or streaming data or other data; information for characterizing genre and contents information, thumbnail information, resume marker information, protect information, temporary delete information, bookmark information, playlist information, still-picture reproduction time information, synchronous audio information, and audio dubbing information; and header length and data length. The header information may include all or part of the information as mentioned in the above.

Further, the header information may additionally include at least some of the following information; a flag indicating which is the data broadcast transmission method is, the data carousel mode, or the event message transmission mode, or the mode including the both; a flag which indicates, in case of the data carousel broadcast, whether the mode is for recording the entire data or only the updated data; a flag which indicates whether the automatic update of old data with new data is set ON or OFF for data broadcast updatable data broadcast such as news, weather forecast and stock information; a flag indicating whether the latest data update start time and end time and a time map exist; and a flag indicating whether the stream is an ordinary broadcast stream or a server-type broadcast stream. The header information may include all or part of the information listed above.

The animated picture data compression method may be distinguished among MPEG video, H.264 video, and Windows (registered trademark) Media video. The audio data compression method may be distinguished among MPEG audio, Dolby audio, and DTS audio. The still-picture data compression method may be distinguished between JPEG and PNG.

The header information may be composed of the following items, for example.

Data corresponding to EXT stream Information #1 to #n (as described above);

Genre and contents information, including genre information, producer information, writer information, performer information;

Thumbnail information, including the address of the corresponding thumbnail;

Resume marker information, including the address of the position where reproduction has been stopped;

Protect information, including a flag indicating whether Protect is OFF (erasable), or ON (unerasable);

Temporary delete information, including a flag indicating whether the condition is the ordinary condition or the temporary delete condition;

Bookmark information, including a flag indicating whether Bookmark is OFF or ON;

Playlist information, including information on stream-to-stream connection set by the user;

Still-picture reproduction time information, including information on time for reproducing the still picture;

Synchronous audio information, including time information of audio synchronized with the still picture;

Audio dubbing information, including dubbing audio address in formation;

Header length, indicating a header Length (number of bytes); and

Data length, indicating a length of the data or a length of the header and the data length (number of bytes).

The header information for the data recorded in the fourth and subsequent files, such as animated pictures, audio, still pictures, animation, text data, game data, electronic program guide data, graphic, and three-dimensional video data can be integrated and recorded as the total header information.

The reference numeral 2404 in FIG. 24 denotes the total header information.

The total header information may include all or part of the header information denoted by 2406, 2408, 2410, and 2412.

In this case, however, the header length is the total of header lengths, the data length is a number of bytes obtained by subtracting the total header from the HR_EXTBC.DAT file, of the number of bytes of the entire HR_EXTBC.DAT file.

According to the data composition as described so far, the header information for the animated picture, the audio, the still picture, the animation, the text data, the game data, the electronic program guide data, the graphic, and the three-dimensional video data are all included in the same HR_EXTBC.DAT file. This enables the data to be edited, deleted, processed, or specialty reproduced rapidly and easily. Specifically, as shown in FIG. 24, the header information for the edited data stored in the fourth file 2404 or in the fourth file and subsequently files is also stored in the same file or files, whereby the edited data stored in the fourth file 2404 and the subsequent files can be reproduced even if the data in the first to third files are deleted. In this case, the edited data can be reproduced rapidly since the management data stored in the first file need not be referred to. In other words, the present invention provides a recording method of storing edited broadcast video/audio data, whose format has been converted to the one corresponding to reproducing equipment, in a separated file from the original broadcast video/audio data.

Further, the present invention provides a data recording medium on which header information and total header information are recorded by any of the methods described above, a data recording apparatus for recording data having header information or total header information, or a data reproducing apparatus for reproducing recorded data having header information or total header information.

The genre and contents information, the thumbnail information, the resume marker information, the protect information, the temporary delete information, the bookmark information, the playlist information, the still-picture reproduction time information, the synchronous audio information, the audio dubbing information, the header length, and the data length may also be arranged in Stream File Information Table (STM_AVFIT), Movie AV File Information Table (M_AVFIT), or Extra Broadcast File Information Table (EXT_AVFIT) in the HR_MANGR.IFO file,

### INDUSTRIAL APPLICABILITY

The present invention is applicable to recording of broadcast video/audio data for various usages on HDDs, DVDs, or the like. The present invention is especially effectively applicable to large-capacity DVDs or the like.

1. A broadcast video/audio data recording method characterized in that management data is recorded in a first file, a stream representing broadcast in TS (Transport Stream) is recorded in a second file, a stream representing video and audio in PS (Program Stream) is recorded in a third file, a subsidiary file is provided separately from the first to third files, and the contents of the data in the files are indicated by the management data in the first file.

2. The broadcast video/audio data recording method according to claim 1, characterized in that the subsidiary file records all or part of input and broadcast video/audio, or copied or moved video/audio from all or part of broadcast video/audio recorded in the second or third file.

3. The broadcast video/audio data recording method according to claim 1, characterized in that the subsidiary file is composed of a plurality of files, and all or part of the input broadcast, video and audio, or the broadcast, video and audio copied or moved from all or part of the broadcast, video and audio recorded in the second or third file are recorded in the plurality of files in the subsidiary file such that the respective combinations of animated pictures having a same encoding format, audios having a same encoding format, still pictures having a same encoding format, animations having a same encoding format, text data having a same encoding format, game data having a same encoding format, electronic program guide data having a same encoding format, graphic having a same encoding format, and three-dimensional video data having a same encoding format are recorded in the same files in the subsidiary file.

4. The broadcast video/audio data recording method according to claim 1, characterized in that data broadcast is recorded in any of the second, third, and subsidiary files while all or part of input broadcast video/audio, or copied or moved video/audio from all or part of the broadcast video/audio recorded in the second, third, or subsidiary file are recorded in fourth or fifth file in the subsidiary file.

5. The broadcast video/audio data recording method according to claim 1, characterized in that all or part of the input broadcast video/audio data or all or part of the data in the files is directly recorded in or copied or moved to a destination file if the format thereof corresponds to that of the destination file, whereas if the format thereof does not correspond to that of the destination file, it is recorded in or copied or moved to the destination file after being converted to the corresponding format.

6. The broadcast video/audio data recording method according to claim 1, characterized in that the PS stream in the third file is a stream obtained by PS encoding analog broadcast.

7. The broadcast video/audio data recording method according to claim 1, characterized in that the PS stream in the third file is a stream obtained by trans-coding digital broadcast from TS to PS.

8. The broadcast video/audio data recording method according to claim 1, characterized in that the broadcast stream represented in TS and recorded in the second file is converted into a video/audio stream represented in PS and is thereafter recorded in the third file by copying or moving the same, and the management data is representative of record information.

9. The broadcast video/audio data recording method according to claim 1, characterized in that the video/audio stream represented in TS and recorded in the third file is converted into a broadcast stream represented in PS and is thereafter recorded in the second file by copying or moving the same, and the management data is representative of record information.

10. The broadcast video/audio data recording method according to claim 1, characterized in that related information except broadcast is recorded in the subsidiary file, and the management data is representative of contents of the related information.

11. The broadcast video/audio data recording method according to claim 1, characterized in that related information except broadcast is recorded in a new file different from the first to third files and the subsidiary file, and the management data is representative of contents of the related information.

12. The broadcast video/audio data recording method according to claim 4, characterized in that the data broadcast includes program-link-type data broadcast, independent-type data broadcast, audio or radio broadcast, and text broadcast.

13. The broadcast video/audio data recording method according to claim 12, characterized in that the program-link-type data broadcast is recorded in the second file, the independent-type data broadcast, the audio or radio broadcast, or the text broadcast is recorded in the subsidiary file.

14. The broadcast video/audio data recording method according to claim 2, characterized in that the data to be copied or moved is all or part of animated picture data, audio data, still-picture data, animation, text data, game data, electronic program guide data, graphic, and three-dimensional video data.

15. The broadcast video/audio data recording method according to claim 11, characterized in that the related information except broadcast is all or part of Internet information related to broadcast, Internet additional information, such as program additional information, director's cut information, director's comment information, E-commerce information, chat information, and prior notice information, and Internet broadcast information.

16. (canceled)

17. The broadcast video/audio data recording method provided with a first file for recording management data and a data file for recording as stored data at least either input broadcast video/audio data, or recorded broadcast video/audio data obtained as a result of copying or moving, the stored data being recorded in the data file in a format indicated by the management data, characterized in that the broadcast video/audio data represented in TS is recorded in a second file, while broadcast video/audio data represented in PS is recorded in a third file, and the recorded data in the second and/or third file(s) is selectively copied or moved to the data file.

18. The broadcast video/audio data recording method according to claim 17, characterized in that there is provided, as the data file, a fourth file for storing data obtained by copying or moving at least part of the input broadcast video/audio data or the recorded data in the second or third file.

19. The broadcast video/audio data recording method according to claim 17, characterized in that the management data is provided and include all or part of a broadcast recording file identification flag, a related information recording file identification flag other than broadcast, a broadcast identification flag, and a related information identification flag except broadcast, and these flags indicate all or part of the file in which the broadcast video/audio data is recorded, the file in which the related information except broadcast is recorded, contents of the recorded broadcast video/audio data, and contents of the recorded related information except broadcast.

20. The broadcast video/audio data recording method according to claim 19, characterized in that:
the broadcast recording file identification flag and the related information recording file identification flag other than broadcast indicate whether or not ordinary digital broadcast without data broadcast, ordinary digital broadcast with program-link-type data broadcast, independent-type data broadcast, audio or radio broadcast, text broadcast, and analog broadcast are recorded in their corresponding files, or the files in which the respective broadcasts are recorded, or indicate whether or not related information other than broadcast is recorded in its corresponding file, or the file in which the related information other than broadcast is recorded;
the broadcast identification flag and the related information identification flag other than broadcast indicate all or part of:
whether or not ordinary digital broadcast without data broadcast, ordinary digital broadcast with program-Link-type data broadcast, independent-type data broadcast, audio or radio broadcast, text broadcast, analog broadcast, and related information other than broadcast are recorded in their corresponding streams,
whether the relevant data in the recorded broadcast data or the recorded related information other than broadcast has been directly recorded or has been copied or moved from other files;
whether there is a source or not when the data has been copied or moved, and, when there is a source, a file name, a source stream name, and source stream number;
which type of data the source data and the recorded data are, when the data has been copied or moved and its source is known, while otherwise the recorded data is, among animated pictures, audio, still pictures, animation, text data, game data, electronic program guide data, graphic data, and three-dimensional video data; an animated picture data compression method when the data is animated picture data, an audio data compression method when the data is audio, a still-picture data compression method when the data is still-picture data, an animation data compression method when the data is animation data, a text data compression display method when the data is text data, a game data method when the data is game data, an electronic program guide method when the data is electronic program guide data, a graphic method when the data is graphic, a three-dimensional video data method when the data is three-dimensional video data, and a stream mode, and a flag indicating whether the related information other than broadcast is ordinary Internet data or streaming data or other data.

21. The broadcast video/audio data recording method according to claim 1, characterized in that the first file records as the management data all or part of:
a broadcast recording file identification flag, a related information recording file identification flag other than broadcast, a broadcast identification flag, and a related information identification flag other than broadcast;
a flag which indicates whether the data broadcast transmission method is the data carousel mode, or the event message transmission mode, or the mode including both, a flag which indicates, in case of data carousel broadcast, whether the mode is for recording all the data or for recording only updated data, a flag which indicates, in broadcast of updatable data such as news, weather forecast, and stock information, whether the automatic update of old data with new data is set ON or OFF, a flag which indicates whether or not the latest data update start time and end time and a time map exist, and a flag which indicates whether the stream is an ordinary broadcast stream or a server-type broadcast stream.

22. The broadcast video/audio data recording method according to claim 20, characterized in that indications are made about whether the animated picture data compression method is, MPEG video, or H.264 video, or Windows (registered trademark) Media video, about whether the audio data compression method is, MPEG audio, or Dolby audio, or DTS audio, and about whether the still-picture data compression method is, JPEG or PNG.

23. A broadcast video/audio data recording apparatus for recording data by the recording method according to claim 1, and/or a broadcast video/audio data reproducing apparatus for reproducing the data by the recording method according to claim 1.

24. (canceled)

25. A broadcast video/audio data recording medium recorded by the recording method according to claim 1.

26. (canceled)

27. (canceled)

28. (canceled)

29. (canceled)

30. (canceled)

31. (canceled)

32. (canceled)

33. A broadcast video/audio data recording apparatus characterized by comprising:
a first file for recording management data;
a second file for recording a stream in which broadcast is represented in TS (Transport Stream);
a third file for recording a stream in which video/audio is represented in PS (Program Stream); and
a subsidiary file provided separately from the first to third files,
the contents of the broadcast video/audio data recorded in the files being indicated by the management data.

34. The broadcast video/audio data recording apparatus according to claim 33, characterized in that the subsidiary file includes a fourth file for recording data copied or moved from all or part of input broadcast video/audio, or all or part of the broadcast video/audio recorded in the second or third file.

35. The broadcast video/audio data recording apparatus according to claim 33, characterized in that the subsidiary file includes files for recording data which are copied or moved from all or part of the input broadcast, video and audio, or all or part of the broadcast, video and audio recorded in the second or third file, while combining animated pictures having a same encoding format, audios having a same encoding format, stilt pictures having a same encoding format, animations having a same encoding format, text data having a same encoding format, game data having a same encoding format, and electronic program guide data having a same encoding format, graphic having a encoding format, and three-dimensional video data having a same encoding format, and recording them in the separate files, respectively,
the contents of the broadcast video/audio data recorded in the files being indicated by the management data.

36. The broadcast video/audio data recording apparatus according to claim 33, characterized in that the second or third file records data broadcast, and the subsidiary file includes a fourth or fifth file for recording data which are copied or moved from all or part of the input broadcast video/audio, or all or part of the broadcast video/audio recorded in the second or third file, the contents of the broadcast video/audio data recorded in the files being indicated by the management data.

37. The broadcast video/audio data recording apparatus according to claim 36, characterized by comprising files for recording data which are copied or moved from all or part of the input broadcast video/audio, or all or part of the broadcast video/audio recorded in the second or third file, by combining animated pictures having a same encoding format, audios having a same encoding format, stilt pictures having a same encoding format, animations having a same encoding format, text data having a same encoding format, game data having a same encoding format, and electronic program guide data having a same encoding format, graphic having a encoding format, and three-dimensional video data having a same encoding format, and recording them in the separate files, respectively,
the contents of the broadcast video/audio data recorded in the files being indicated by the management data.

38. (canceled)

39. The broadcast video/audio data recording apparatus according to claim 33, characterized in that the subsidiary file includes animated pictures, audio, still pictures, animation, text data, game data, electronic program guide data, graphic, and three-dimensional video data each of which is assigned with header information.

40. The broadcast video/audio data recording apparatus according to claim 33, characterized in that the data in the subsidiary file is recorded by individually gathering animated pictures having a same encoding format, audios having a same encoding format, still pictures having a same encoding format, animations having a same encoding format, text data having a same encoding format, game data having a same encoding format, and electronic program guide data having a same encoding format, graphic having a encoding format, and three-dimensional video data having a same encoding format, the gathered data being given header information.

41. The broadcast video/audio data recording apparatus according to claim 33, characterized in that the header information includes at least part of:
a flag indicating whether ordinary digital broadcast without data broadcast, ordinary digital broadcast with program-link-type data broadcast, independent-type data broadcast, audio or radio broadcast, text broadcast, analog broadcast, or related information other than broadcast is recorded or not;
a flag indicating whether the recorded broadcast data or related information other than broadcast has been directly recorded or copied or moved from another file;
a flag which indicates whether there is a source when the data has been copied or moved,;
a file name, a source stream name, and a source stream number when there is a source;
a flag which indicates which the source data and the recorded data are when the data has been copied or moved and the source is known, and otherwise indicates which the recorded data is, among animated pictures, audio, still pictures, animation, text data, game data, electronic program guide data, graphic, and three-dimensional video data;
a flag which indicates an animated picture data compression method when the data is animated pictures, an audio data compression method when the data is audio, a stilt-picture data compression method when the data is still pictures, an animation data compression method when the data is animation, a text data compression display method when the data is text data, a game data method when the data is game data, an electronic program guide method when the data is electronic program guide data, a graphic method when the data is graphic, a three-dimensional video data method when the data is three-dimensional video data, and a stream mode, and whether the related information other than broadcast is ordinary Internet data or streaming data or other data;
genre and contents information, thumbnail information, resume marker information, protect information, temporary delete information, bookmark information, playlist information, still-picture reproduction time information, synchronous audio information, audio dubbing information; and
header Length and data length.

42. The broadcast video/audio data recording apparatus according to claim 41, characterized in that the header information is added with all or part of:
a flag which indicates whether the data broadcast transmission method is a data carousel mode, or an event message transmission mode, or a mode including the both; a flag which indicates, in case of data carousel broadcast, whether the mode is for recording all the data or for recording only updated data; a flag which indicates whether the automatic update of old data with new data is set OFF or ON in broadcast of updatable data such as news, weather forecast, and stock information; a flag which indicates whether or not the latest data update start time and end time, and a time map exist; and a flag which indicates whether the stream is an ordinary broadcast stream or a server-type broadcast stream.

43. The broadcast video/audio data recording apparatus according to claim 41, characterized in that it is indicated which the animated picture data compression method is, MPEG video, or H.264 video, or Windows (registered trademark) Media video, which the audio data compression method is, MPEG audio, or Dolby audio, or DTS audio, and which the still-picture data compression method is, JPEG or PNG.

44. The broadcast video/audio data recording apparatus according to claim 33, characterized in that the subsidiary file records total header information obtained by integrating header information of animated pictures/audios/still pictures/animation/text data/ game data/electronic program guide data/graphic/three-dimensional video data all of which are recorded in the subsidiary file.

45. The broadcast video/audio data recording apparatus according to claim 44, characterized in that the total header information includes all or part of the header information described in claim 41.

46. (canceled)

47. A broadcast video/audio data recording method for storing edited data obtained by editing input broadcast video/audio data in a file different from the input broadcast video/audio data, characterized in that the file for the edited data stores header information for the edited data, together with the edited data.

48. The broadcast video/audio data recording method according to claim 47, characterized in that the header information is for at least one of animated pictures, audio, still pictures, animation, text data, game data, electronic program guide data, graphic, and three-dimensional video data.

49. The broadcast video/audio data recording method according to claim 47, characterized in that the header information is assigned to and represents each of integrations of data obtained by individually integrating animated pictures having a same encoding format, audios having a same encoding format, still pictures having a same encoding format, animations having a same encoding format, text data having a same encoding format, game data having a same encoding format, and electronic program guide data having a same encoding format, graphic having a encoding format, and three-dimensional video data having a same encoding format.

50. The broadcast video/audio data recording method according to claim 47, characterized in that the header information includes at least part of:
a flag indicating whether ordinary digital broadcast without data broadcast, ordinary digital broadcast with program-link-type data broadcast, independent-type data broadcast, audio or radio broadcast, text broadcast, analog broadcast, or related information other than broadcast is recorded or not;
a flag indicating whether the recorded broadcast data or related information other than broadcast has been directly recorded or copied or moved from another file;,
a flag which indicates whether there is a source when the data has been copied or moved,;
a file name, a source stream name, and a source stream number when there is a source;
a flag which indicates which the source data and the recorded data are when the data has been copied or moved and the source is known, and otherwise indicates which the recorded data is, among animated pictures, audio, still pictures, animation, text data, game data, electronic program guide data, graphic, and three-dimensional video data;
a flag which indicates an animated picture data compression method when the data is animated pictures, an audio data compression method when the data is audio, a still-picture data compression method when the data is still pictures, an animation data compression method when the data is animation, a text data compression display method when the data is text data, a game data method when the data is game data, an electronic program guide method when the data is electronic program guide data, a graphic method when the data is graphic, a three-dimensional video data method when the data is three-dimensional video data, and a stream mode, and whether the related information other than broadcast is ordinary Internet data or streaming data or other data;
genre and contents information, thumbnail information, resume marker information, protect information, temporary delete information, bookmark information, playlist information, still-picture reproduction time information, synchronous audio information, audio dubbing information; and
header length and data length.

51. The broadcast video/audio data recording method according to claim 50, characterized in that the header information further additionally includes all or part of:
a flag which indicates whether the data broadcast transmission method is a data carousel mode, or an event message transmission mode, or a mode including the both; a flag which indicates, in case of data carousel broadcast, whether the mode is for recording all the data or for recording only updated data; a flag which indicates whether the automatic update of old data with new data is set OFF or ON in broadcast of updatable data such as news, weather forecast, and stock information; a flag which indicates whether or not the latest data update start time and end time, and a time map exist; and a flag which indicates whether the stream is an ordinary broadcast stream or a server-type broadcast stream.

52. (canceled)

53. A data recording medium recording data that is recorded by the broadcast video/audio data recording method according to claim 47.

54. A data recording apparatus for recording data by the broadcast video/audio data recording method according to claim 47.

55. A data reproducing apparatus for reproducing data by the broadcast video/audio data recording method according to claim 47.
